(19) United States
(12) Patent Application Publication
(10) Pub. No.: US 2025/0075090 A1
(43) Pub. Date: Mar. 6, 2025

(54) INK JET RECORDING METHOD, INK JET RECORDING APPARATUS AND SET OF AQUEOUS INK AND AQUEOUS REACTION LIQUID

(71) Applicant: CANON KABUSHIKI KAISHA, Tokyo (JP)

(72) Inventors: ARIHIRO SAITO, Saitama (JP); TAKATOSHI TANAKA, Tokyo (JP); SHINYA YUMOTO, Kanagawa (JP); TOSHIHIRO OMAGARI, Kanagawa (JP); ERI KOBAYASHI, Kanagawa (JP); KENTARO YOSHIZAWA, Kanagawa (JP)

(21) Appl. No.: 18/818,306

(22) Filed: Aug. 28, 2024

(30) Foreign Application Priority Data
Aug. 30, 2023 (JP) 2023-139405
Aug. 8, 2024 (JP) 2024-131739

(51) Int. Cl. C09D 11/54; B41M 3/00; B41M 5/00; C09D 11/106; C09D 11/40

(52) U.S. Cl. CPC C09D 11/54; B41M 3/001; B41M 5/0011; C09D 11/106; C09D 11/40

(57) ABSTRACT

There is provided an ink jet recording method for recording an image on a recording medium using an aqueous ink and an aqueous reaction liquid containing a reactant. The reactant contains a cationic resin. The cationic resin contains, in a molecular weight distribution measured by gel permeation chromatography (GPC), a first cationic resin having a peak in a molecular weight range of 100,000 or more to 500,000 or less and a second cationic resin having a peak in a molecular weight range of 2,000 or more to less than 100,000. The mass ratio of the amount (% by mass) of the second cationic resin contained to the amount (% by mass) of the first cationic resin contained is 0.01 times or more to 8.0 times or less.

### BACKGROUND OF THE INVENTION

### Field of the Invention

The present invention relates to an ink jet recording method, an ink jet recording apparatus and a set of an aqueous ink and an aqueous reaction liquid.

### Description of the Related Art

It is known that an ink jet recording apparatus records an image on a recording medium by discharging a minute ink droplet from a nozzle of a recording head. In recent years, it has been required to record an image on a recording medium having low ink absorbency such as art paper having a coating layer (hereinafter, also referred to as a “low-absorbency recording medium”) or a recording medium having no ink absorbency such as a plastic film (hereinafter, also referred to as a “non-absorbency recording medium”). In addition, as the ink, the use of an aqueous ink has been studied from the viewpoints of the environment, safety and the like.

So far, for recording media with high ink absorbency, such as plain paper, practical image quality has been obtained by using aqueous inks as described above. However, in the case of the low-absorbency recording medium or the non-absorbency recording medium, the applied ink droplets are not easily absorbed or substantially not absorbed by the recording medium; thus, the image is substantially not fixed due to the absorption of the ink. This causes ink droplets to coalesce on the recording medium, resulting in blurriness and unevenness in the image and making it difficult to achieve practical image quality.

To address the above problems, Japanese Patent Laid-Open No. 8-224955 and International Publication No. 2019/116536 each disclose the use of a reaction liquid containing a cationic substance that reacts with the solid content such as a pigment and a resin in the ink to cause aggregation and thickening).

### SUMMARY OF THE INVENTION

The present invention is directed to providing an ink jet recording method by which image unevenness can be inhibited when an ink and a reaction liquid are discharged from an ink jet recording head onto a recording medium to record an image, by which image fading can be inhibited when images are continuously recorded and by which image unevenness at a recording start portion of an image can be inhibited when the image is recorded after a stop for a certain period of time. The present invention is also directed to providing an ink jet recording apparatus and a set of an aqueous ink and an aqueous reaction liquid for use in the ink jet recording method.

One disclosed aspect of the present invention is directed to providing an ink jet recording method for recording an image on a recording medium using an aqueous ink and an aqueous reaction liquid containing a reactant that reacts with the aqueous ink. The method includes a reaction liquid applying step of applying the aqueous reaction liquid to the recording medium by discharging the aqueous reaction liquid from an ink jet recording head, and an ink applying step of applying the aqueous ink to the recording medium by discharging the aqueous ink from an ink jet recording head in such a manner as to overlap at least a portion of a region of the recording medium to which the aqueous reaction liquid is applied. The reactant contains a cationic resin. The cationic resin contains, in a molecular weight distribution measured by gel permeation chromatography, a first cationic resin having a peak in a molecular weight range of 100,000 or more to 500,000 or less, and a second cationic resin having a peak in a molecular weight range of 2,000 or more to less than 100,000. The mass ratio of the amount (% by mass) of the second cationic resin contained to the amount (% by mass) of the first cationic resin contained is 0.01 times or more to 8.0 times or less.

Further features of the present invention will become apparent from the following description of exemplary embodiments with reference to the attached drawings.

### BRIEF DESCRIPTION OF THE DRAWINGS

FIG. 1 is a schematic view illustrating an ink jet recording apparatus according to an embodiment of the present invention.

FIG. 2 is a perspective view illustrating an example of a liquid applying device.

FIG. 3 is a sectional perspective view illustrating an example of a discharge element substrate.

FIG. 4 is a schematic view illustrating an example of a liquid supply system.

FIG. 5 is a schematic view illustrating another example of a heating portion.

FIG. 6 is a schematic view illustrating another example of a fixing portion.

### DESCRIPTION OF THE EMBODIMENTS

An ink and a reaction liquid described in Japanese Patent Laid-Open No. 8-224955 or International Publication No. 2019/116536 were applied by ink jet recording heads to low-absorbency recording media to form images. The results indicated that it was effective in reducing blurriness and unevenness in the images.

Studies by the inventors have revealed that when a large number of images were continuously recorded using the above reaction liquid and ink, image fading occurred. It was also found that when the above-mentioned reaction liquid was discharged again after the discharge operation was stopped for a certain period of time, discharge failure occurred at a recording start portion of an image, resulting in image unevenness at the recording start portion of the image.

The inventors have conducted intensive studies on an ink jet recording method by which image unevenness can be inhibited when an ink and a reaction liquid are discharged from an ink jet recording head onto a recording medium to record an image, by which image fading can be inhibited when images are continuously recorded and by which image unevenness at a recording start portion of an image can be inhibited when the image is recorded after a stop for a certain period of time, an ink jet recording apparatus and a set of an aqueous ink and an aqueous reaction liquid for use in the ink jet recording method, and have completed the present invention.

The present invention will be described in more detail below with reference to embodiments. In an embodiment of the present invention, when a compound is a salt, the salt in an ink is present in the form of dissociated ions. However, for convenience, it is referred to as “the ink contains the salt”. An aqueous ink and a reaction liquid for ink jet recording are also referred to simply as an “ink” and a “reaction liquid”, respectively. Unless otherwise specified, physical property values are values at room temperature (25° C.). The term “(meth)acrylic acid” refers to “acrylic acid” and “methacrylic acid”. The term “(meth)acrylate” refers to “acrylate” and “methacrylate”. In an embodiment of the present invention, the order of application of a reaction liquid and an ink is not limited to a particular order. However, in order to more easily provide the effect of the present invention, the order in which an ink is applied after a reaction liquid is applied to a recording medium can be used. Hereinafter, the order in which an ink is applied after a reaction liquid is applied to a recording medium will be described as an example.

The inventors have conducted studies in order to inhibit image unevenness that is particularly likely to occur when a reaction liquid and an ink are applied to a low-absorbency or non-absorbency recording medium using an ink jet recording apparatus and have found that image unevenness occurs due to the flow of ink that has landed on a recording medium. To inhibit the flow of ink, it is important to promote the aggregation and thickening of the ink. Thus, the inventors have conducted further studies using a reaction liquid containing a cationic resin in order to inhibit image unevenness by promoting the aggregation and thickening of ink.

The results indicated that although image unevenness was inhibited by using a reaction liquid containing a cationic resin and an ink, image fading occurred when a large number of images were continuously recorded. Analysis of the cause of the image fading revealed that the deposit of sticking matter on the discharge port surface of the recording head serving as an ink-side liquid applying device resulted in ink discharge failure, causing the image fading. Further analysis revealed that when a reaction liquid and an ink were discharged from an ink jet recording head, a small droplet, which is what is called a satellite droplet, was generated as a droplet of the reaction liquid, the small droplet being formed by the break of the main droplet. The inventors speculated that the satellite droplet did not land on a recording medium, floated, adhered to the ink-side discharge port surface and then came into contact with the ink, resulting in the formation of sticking matter. To reduce the generation of the satellite droplet of the reaction liquid, the inventors have focused on the fact that the main droplet of the reaction liquid at the time of discharge from the recording head needs to be less likely to break and have conducted studies on this issue. The results indicated that the generation of the satellite droplet was reduced by using a cationic resin having a relatively high molecular weight. In other words, the inventors have speculate that the use of the cationic resin having a relatively high molecular weight improves the spinnability of the droplet of the reaction liquid due to the formation of a hydrogen bond between the cationic resin molecules, thereby inhibiting the droplet from breaking. Specifically, the inventors have found that when a first cationic resin having a peak in a molecular weight range of 100,000 or more to 500,000 or less in a molecular weight distribution measured by gel permeation chromatography (GPC) is used as a cationic resin, the generation of a satellite droplet of the reaction liquid is reduced to inhibit image fading.

However, it was found that when a reaction liquid containing the above-mentioned first cationic resin having a high molecular weight was used, in the case where the discharge operation of the reaction liquid by a recording head was stopped for a certain period of time and then performed again, image unevenness occurred at the recording start portion of an image. The inventors speculated that this was because water in the reaction liquid in the discharge port of the recording head evaporated during a stop for a certain period of time to lead to a significant increase in the viscosity of the reaction liquid in the nozzle, thereby failing to discharge the reaction liquid at the recording start portion of the image.

To address the above problems, the inventors have conducted intensive studies and have found that the use of a second cationic resin having a relatively low molecular weight in addition to the first cationic resin having a high molecular weight can inhibit image unevenness at the recording start portion of an image after a stop for a certain period of time. Specifically, the inventors have found that it is important to use the second cationic resin having a peak in a molecular weight range of 2,000 or more to less than 100,000 in a molecular weight distribution measured by GPC in combination with the first cationic resin. That is, the use of the first cationic resin having a high molecular weight in combination with the second cationic resin having a low molecular weight can inhibit the increase in viscosity upon evaporation of water, compared with the case where the first cationic resin having a high molecular weight is used alone. Therefore, the discharge property of the reaction liquid after a stop for a certain period of time is improved to inhibit image unevenness at the recording start portion of an image.

To deal with the above problems, the ratio of the first cationic resin content to the second cationic resin content of the reaction liquid is also important. Specifically, the mass ratio of the second cationic resin content (% by mass) to the first cationic resin content (% by mass) needs to be 0.01 times or more to 8.0 times or less. When the mass ratio of the second cationic resin content (% by mass) to the first cationic resin content (% by mass) is 0.01 times or more, image unevenness at the recording start portion of an image can be inhibited. At 8.0 times or less, the generation of a satellite droplet can be inhibited to inhibit image fading.

When the reaction liquid contains a cationic resin having a peak in a molecular weight range of less than 100,000 instead of the first cationic resin, the generation of a satellite droplet cannot be sufficiently inhibited, and an image fading level required for an embodiment of the present invention cannot be achieved. When the reaction liquid contains a cationic resin having a peak in a molecular weight range of more than 500,000 instead of the first cationic resin, the viscosity in a discharge port after a stop for a certain period of time increases excessively, and the reaction liquid is not normally discharged at the start of image recording, thereby resulting in image unevenness at the recording start portion of the image.

When the reaction liquid contains a cationic resin having a peak in a molecular weight region of less than 2,000 instead of the second cationic resin, the generation of a satellite droplet cannot be sufficiently inhibited, and an image fading inhibition level required for an embodiment of the present invention cannot be achieved. When the reaction liquid contains a cationic resin having a peak in a molecular weight range of 100,000 or more instead of the second cationic resin, the viscosity in the discharge port increases excessively after a stop for a certain period of time, and the reaction liquid is not normally discharged at the start of recording, thereby resulting in image unevenness in the recording start portion.

The image unevenness that occurs when the above-mentioned ink and reaction liquid are used is a phenomenon that is particularly likely to occur when a low-absorbency or non-absorbency recording medium is used as the recording medium. In the present specification, the term “low-absorbency recording medium” refers to a recording medium that absorbs water in an amount of 4 mL/m² or more to 10 mL/m² or less from the start of contact to 30 msec^{1/2} in the Bristow method. The term “non-absorbency recording medium” refers to a recording medium that absorbs water in an amount of 0 mL/m² or more to less than 4 mL/m² from the start of contact to 30 msec^{1/2} in the Bristow method. That is, the low-absorbency recording medium and the non-absorbency recording medium are recording media that absorb water in an amount of 0 mL/m² or more to 10 mL/m² or less from the start of contact to 30 msec^{1/2} in the Bristow method. In the case of an absorbent recording medium, such as plain paper, having a relatively high permeation rate of the ink and the reaction liquid (the amount of water absorbed from the start of contact to 30 msec^{1/2} is more than 10 mL/m² in the Bristow method), the reaction liquid permeates quickly immediately after being applied to the recording medium. After the ink applied to the recording medium comes into contact with the reaction liquid, a pigment and an aqueous medium also permeate the recording medium while aggregating. Thus, the ink does not flow on the surface of the recording medium; hence, there is almost no movement of the pigment, and image unevenness is unlikely to occur. In the case of the low-absorbency and non-absorbency recording media, which hardly absorb the ink and the reaction liquid, the reaction liquid hardly permeates, and thus the reaction liquid and the ink are present on the surfaces of the low-absorbency and non-absorbency recording media. For this reason, the ink flows easily on the surfaces of the recording media to easily cause image unevenness. However, in an embodiment of the present invention, even when low-absorbency and non-absorbency recording media that are likely to cause image unevenness are used, the ink is sufficiently thickened upon contact with the reaction liquid; hence, the ink is less likely to flow, and thus image unevenness is less likely to occur.

### Ink Jet Recording Method, Ink Jet Recording Apparatus and Set of Aqueous Ink and Aqueous Reaction Liquid

An ink jet recording method according to an embodiment of the present invention (hereinafter, also referred to simply as a “recording method”) is an ink jet recording method for recording an image on a recording medium using an aqueous ink and an aqueous reaction liquid containing a reactant that reacts with the aqueous ink. The method includes a reaction liquid applying step of applying the aqueous reaction liquid to the recording medium by discharging the aqueous reaction liquid from an ink jet recording head, and an ink applying step of applying the aqueous ink to the recording medium by discharging the aqueous ink from an ink jet recording head in such a manner as to overlap at least a portion of a region of the recording medium to which the aqueous reaction liquid is applied. The reactant contains a cationic resin. The cationic resin contains, in the molecular weight distribution of the reaction liquid measured by gel permeation chromatography, a first cationic resin having a peak in a molecular weight range of 100,000 or more to 500,000 or less, and a second cationic resin having a peak in a molecular weight range of 2,000 or more to less than 100,000. The mass ratio of the second cationic resin content (% by mass) to the first cationic resin content (% by mass) is 0.01 times or more to 8.0 times or less.

An ink jet recording apparatus according to an embodiment of the present invention (hereinafter, also referred to simply as a “recording apparatus”) is an ink jet recording apparatus for use in an ink jet recording method for recording an image on a recording medium using an aqueous ink and an aqueous reaction liquid containing a reactant that reacts with the aqueous ink, and is a recording apparatus that can be used for the above-described recording method. The recording apparatus includes an ink jet-type reaction liquid applying unit configured to apply the aqueous reaction liquid to a recording medium by discharging the aqueous reaction liquid, and an ink jet-type ink applying unit configured to apply the aqueous ink to the recording medium by discharging the aqueous ink in such a manner as to overlap at least a portion of a region of the recording medium to which the aqueous reaction liquid is applied.

A set of an aqueous ink and an aqueous reaction liquid according to an embodiment of the present invention (hereinafter, also referred to simply as a “set”) is a set for use in an ink jet recording method for recording an image on a recording medium using the aqueous ink and the aqueous reaction liquid containing a reactant that reacts with the aqueous ink, and can be used for the above-described recording method. The form of the ink set includes a set of a plurality of independent ink cartridges containing the respective inks (reaction liquid); and an integrated ink cartridge including a plurality of ink storage portions containing the respective inks (reaction liquid). The set according to an embodiment of the present invention is not limited to the above-mentioned forms and may be in any form as long as it is configured in such a manner that the ink and the reaction liquid can be used in combination.

The recording method and recording apparatus according to an embodiment of the present invention will be described in detail below.

### Ink Jet Recording Apparatus

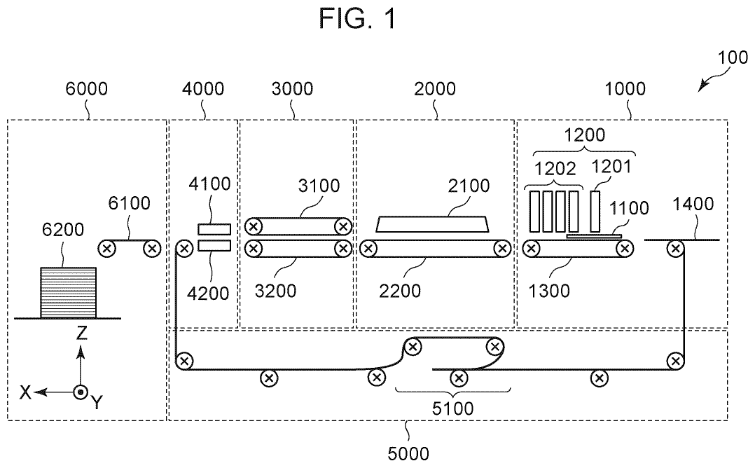

An ink jet recording apparatus will be described in detail below with reference to the drawings. FIG. 1 is a schematic view illustrating an ink jet recording apparatus according to an embodiment of the present invention. The ink jet recording apparatus according to the present embodiment is an ink jet recording apparatus that records an image on a recording medium using an ink and a reaction liquid containing a reactant that reacts with the ink. An X-direction, a Y-direction and a Z-direction represent the width direction (total length direction), depth direction and height direction of the ink jet recording apparatus, respectively. The recording medium is conveyed in the X-direction.

An ink jet recording apparatus 100 of the present embodiment illustrated in FIG. 1 includes a recording portion 1000, a heating portion 2000, a fixing portion 3000, a cooling portion 4000, a reversing portion 5000 and a sheet delivery portion 6000. In the recording portion 1000, various liquids, such as a reaction liquid and an ink, are applied to a recording medium 1100, which has been conveyed from a sheet feeding device 1400 by a conveying member 1300, by a liquid applying device 1200. In the heating portion 2000, the liquids applied to the recording medium 1100 are heated by a heating device 2100 to evaporate volatile components, such as water, in the liquids, thereby performing drying. In the fixing portion 3000, a fixing member 3100 is brought into contact with the region of the recording medium 1100, to which the liquids have been applied, to heat the region, to thereby promote the fixation of an image to the recording medium 1100. The recording medium 1100 is then cooled by the cooling member 4100 of the cooling portion 4000. When an image is to be recorded on the rear surface of the recording medium subsequently to the front surface (recording surface) thereof, first, the recording medium 1100 is reversed by the reversing device 5100 of the reversing portion 5000. After the image is recorded on the rear surface as in the case of the front surface, the recording medium is conveyed by the conveying member 6100 of the sheet delivery portion 6000 and stacked and stored in a recording medium storage portion 6200.

Any medium may be used as the recording medium 1100. For example, such recording media each having ink absorbency (permeability) as described below may each be used as the recording medium 1100: a recording medium free of a coating layer, such as plain paper, uncoated paper or synthetic paper; and a recording medium including a coating layer, such as printing paper, glossy paper or art paper. In addition, a recording medium that does not have permeability like a film or sheet composed of a resin material, such as polyvinyl chloride (PVC) or polyethylene terephthalate (PET), may be used. The basis weight (g/m²) of the recording medium 1100 is preferably 30 g/m² or more to 500 g/m² or less, more preferably 50 g/m² or more to 450 g/m² or less.

### Recording Portion

The recording portion 1000 includes the liquid applying device 1200. The liquid applying device 1200 includes a reaction liquid applying device 1201, which is a reaction liquid applying unit, and an ink applying device 1202, which is an ink applying unit. The reaction liquid applying device 1201 is an ink jet discharge head (recording head) that discharges a reaction liquid to apply the reaction liquid to a recording medium. The reaction liquid may be applied by the reaction liquid applying device 1201 before or after the application of the ink as long as the liquid can be brought into contact with the ink on the recording medium 1100. However, to record high-quality images on various recording media having different liquid-absorbing characteristics, the reaction liquid can be applied before the application of the ink. The ink applying device 1202 is an ink jet discharge head (recording head) that discharges the ink to apply the ink to a recording medium. Examples of the discharge system of the discharge head serving as the liquid applying device 1200 include a system including causing film boiling in a liquid with an electrothermal converter to form an air bubble, to thereby discharge the liquid; and a system including discharging the liquid with an electromechanical transducer.

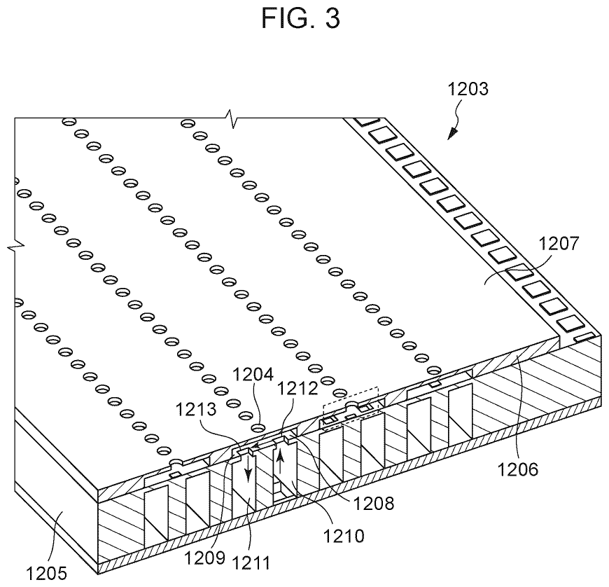

The liquid applying device 1200 is a line head arranged in the Y-direction in an extended manner, and its discharge ports are arrayed in a range covering the image recording region of the recording medium having the maximum usable width. The discharge head has a discharge port surface 1207 (FIG. 3) including a discharge port on its lower side, which is adjacent to the recording medium 1100. The discharge port surface faces the recording medium 1100 with a minute distance of about several millimeters therebetween.

Multiple ink applying devices 1202 may be arranged for applying inks of respective colors to the recording medium 1100. For example, when respective color images are recorded with a yellow ink, a magenta ink, a cyan ink and a black ink, the four ink applying devices 1202 that discharge the above-mentioned four types of inks are arranged side by side in the X-direction. The ink and the reaction liquid are hereinafter sometimes collectively referred to as “liquids”.

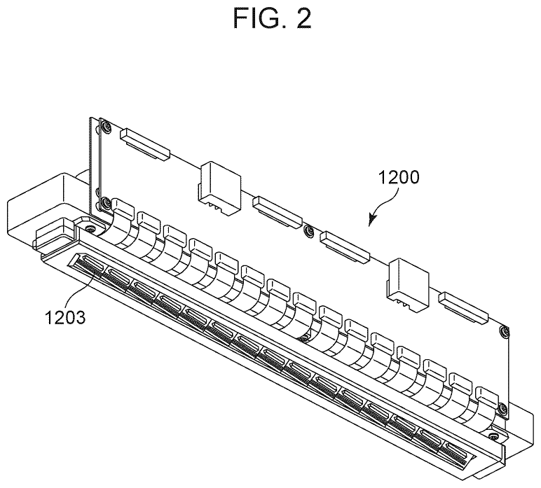

FIG. 2 is a perspective view illustrating an example of the liquid applying device. The liquid applying device 1200 illustrated in FIG. 2 is a line head. The line head includes multiple discharge element substrates 1203 that have discharge port arrays and that are linearly arranged. In each of the discharge element substrates 1203, the multiple discharge port arrays are arranged.

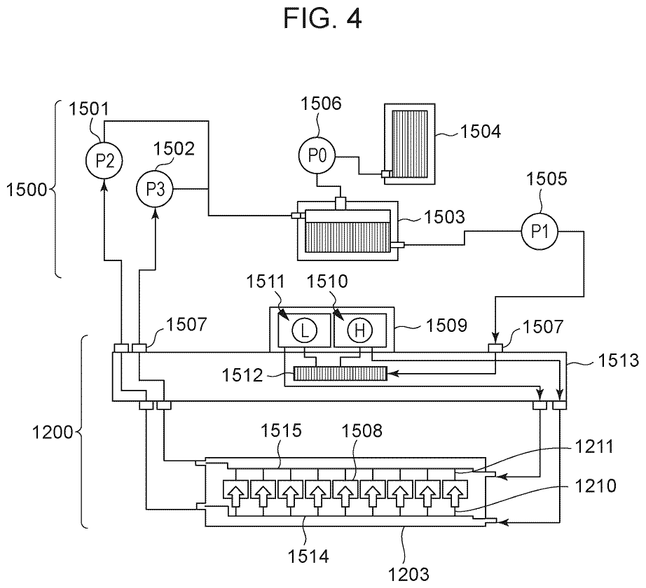

FIG. 3 is a sectional perspective view illustrating an example of each of the discharge element substrates. The discharge element substrate 1203 illustrated in FIG. 3 includes a discharge port forming member 1206 having a discharge port 1204 opened, and a substrate 1205 having a discharge element (not illustrated) arranged thereon. The lamination of the discharge port forming member 1206 and the substrate 1205 forms a first flow path 1208 and a second flow path 1209 through which a liquid flows. The first flow path 1208 is a region from an inflow port 1212, into which the liquid flows from an inflow path 1210, to a portion between each of the discharge ports 1204 and a corresponding one of the discharge elements (FIG. 4, a liquid chamber 1508). The second flow path 1209 is a region from the portion between the discharge port 1204 and the discharge element (FIG. 4, the liquid chamber 1508) to an outflow port 1213 from which the liquid flows out to an outflow path 1211. For example, if a pressure difference is provided between the inflow port 1212 and the outflow port 1213, such as the inflow port 1212 having a high pressure and the outflow port 1213 having a low pressure, the liquid can be allowed to flow from the higher-pressure side to the lower-pressure side (in the direction of the arrow in FIG. 3). The liquid passed through the inflow path 1210 and the inflow port 1212 enters the first flow path 1208. The liquid passed through the portion between the discharge port 1204 and the discharge element (FIG. 4, the liquid chamber 1508) flows to the outflow path 1211 through the second flow path 1209 and the outflow port 1213.

### Supply System

FIG. 4 is a schematic view illustrating an example of a supply system for a liquid such as an ink. A supply portion 1500 of the liquid applying device 1200 illustrated in FIG. 4 includes a first circulation pump (high-pressure side) 1501, a first circulation pump (low-pressure side) 1502, a sub tank 1503, and a second circulation pump 1505. The sub tank 1503 connected to a main tank 1504 serving as a liquid storage portion has an air communication port (not illustrated) and hence can discharge air bubbles mixed into a liquid to the outside of a circulation system. The sub tank 1503 is also connected to a replenishment pump 1506. A liquid is consumed in the liquid applying device 1200 by the discharge (ejection) of the liquid from a discharge port in, for example, image recording or suction recovery. The replenishment pump 1506 transfers the liquid from the main tank 1504 to the sub tank 1503 in an amount corresponding to the amount consumed.

The first circulation pump (high-pressure side) 1501 and the first circulation pump (low-pressure side) 1502 allows the liquid in the liquid applying device 1200, which has been caused to flow out from a connection portion (inflow portion) 1507, to flow to the sub tank 1503. A positive-displacement pump having a quantitative liquid-delivering ability can be used as each of the first circulation pump (high-pressure side) 1501, the first circulation pump (low-pressure side) 1502 and the second circulation pump 1505. Examples of such positive-displacement pump include a tube pump, a gear pump, a diaphragm pump and a syringe pump. At the time of the driving of each of the discharge element substrates 1203, the liquid can be allowed to flow from a common inflow path 1514 to a common outflow path 1515 by the first circulation pump (high-pressure side) 1501 and the first circulation pump (low-pressure side) 1502.

A negative pressure control unit 1509 includes two pressure adjusting mechanisms in which control pressures different from each other are set. A pressure adjusting mechanism (high-pressure side) 1510 and a pressure adjusting mechanism (low-pressure side) 1511 are connected to the common inflow path 1514 and the common outflow path 1515, respectively, in the discharge element substrate 1203 through a supply unit 1513 having arranged therein a filter 1512 that removes foreign matter from a liquid. The discharge element substrate 1203 includes the common inflow path 1514, the common outflow path 1515, and the inflow path 1210 and the outflow path 1211 that communicate with the liquid chamber 1508 serving as the portion between the discharge port 1204 and the discharge element (not illustrated). The inflow path 1210 and the outflow path 1211 communicate with the common inflow path 1514 and the common outflow path 1515, respectively. Accordingly, a flow (arrow in FIG. 4) occurs in which part of the liquid passes the inside of the liquid chamber 1508 from the common inflow path 1514 to flow to the common outflow path 1515. The arrows in FIG. 3 indicate the flow of the liquid in the liquid chamber 1508. That is, as illustrated in FIG. 3, the liquid in the first flow path 1208 flows to the second flow path 1209 through a portion between the discharge port 1204 and the discharge element.

As illustrated in FIG. 4, the pressure adjusting mechanism (high-pressure side) 1510 is connected to the common inflow path 1514, and the pressure adjusting mechanism (low-pressure side) 1511 is connected to the common outflow path 1515. Accordingly, a pressure difference is provided between the inflow path 1210 and the outflow path 1211. Thus, a pressure difference is also provided between the inflow port 1212 (FIG. 3) communicating with the inflow path 1210 and the outflow port 1213 (FIG. 3) communicating with the outflow path 1211. When a liquid is allowed to flow by the pressure difference between the inflow port 1212 and the outflow port 1213, the flow rate (mm/s) of the liquid can be controlled to 0.1 mm/s or more to 10.0 mm/s or less.

### Conveyance System

As illustrated in FIG. 1, the recording portion 1000 includes the liquid applying device 1200 and the conveying member 1300 that conveys the recording medium 1100. The reaction liquid and the ink are applied to the desired positions of the recording medium 1100, which is conveyed by the conveying member 1300, by the liquid applying device 1200. The respective liquid applying devices 1200 receive the image signal of recording data to apply the required reaction liquid and ink to the respective positions. Although the conveying member 1300 in the form of a conveying belt is illustrated in FIG. 1, for example, a spur or a conveying cylinder may be used as long as the spur or the conveying cylinder has a function of conveying the recording medium 1100. To improve conveyance accuracy, a member that can fix the recording medium 1100 can be used as the conveying member 1300. Specific examples thereof include a technique including arranging holes in the conveying member 1300 and suctioning the recording medium 1100 from its rear surface side to fix the recording medium; and a technique including forming the conveying member 1300 from an appropriate material and electrostatically adsorbing the recording medium 1100 to fix the recording medium.

### Heating Portion

As illustrated in FIG. 1, the heating portion 2000 includes a heating device 2100 and a conveying member 2200. The recording medium 1100 to which the reaction liquid and the ink have been applied and on which an image has been recorded is heated by the heating device 2100 while being conveyed by the conveying member 2200, thereby evaporating the liquid component of the image to dry the image. The recording method can further include, between an ink applying step and a fixing step, a drying step of subjecting the recording medium to which the ink has been applied to non-contact heating to dry the ink. When the drying step is included, the deformation (cockling or curl) of the recording medium 1100 can be effectively inhibited.

The heating device 2100 may have any configuration as long as the device can heat the recording medium 1100. Various devices used in the art, such as a warm-air dryer and a heater, may each be used. Of these, a non-contact heater, such as a heating wire or an infrared heater, can be used in terms of safety and energy efficiency. To jet a heated gas to the recording medium 1100, the use of a mechanism for blowing a warm gas with a built-in fan easily improves the drying efficiency.

With regard to a method for the heating, the recording medium 1100 may be heated from the side of a surface (recording surface (front surface)) to which the reaction liquid and the ink have been applied, may be heated from its rear surface side or may be heated from both the surfaces. The conveying member 2200 may have a heating function. Although the conveying member 2200 using a conveying belt is illustrated in FIG. 1, for example, a spur or a conveying cylinder may be used as long as the spur or the conveying cylinder has the function of conveying the recording medium 1100. From the viewpoint of inhibiting the deformation of the recording medium 1100 by the heating, a configuration can be used in which the recording medium 1100 is conveyed while brought into close contact with the conveying member 2200 by blowing air from the heating portion 2000, or a mechanism can be arranged by which the recording medium is fixed to the conveying member 2200. Specific examples thereof include a technique including arranging holes in the conveying member 2200 and suctioning the recording medium 1100 from its rear surface side to fix the recording medium; and a technique including forming the conveying member 2200 from an appropriate material and electrostatically adsorbing the recording medium 1100 to fix the recording medium.

A heating temperature can be set in such a manner that a liquid component is quickly evaporated and that the recording medium 1100 is not overdried from the viewpoint of inhibiting the deformation of the recording medium 1100. In view of the conveying speed and the environmental temperature, the temperature of a dryer can be set in such a manner that the recording medium has a desired temperature. Specifically, the temperature of the dryer, such as a warm-air dryer, is preferably set to 40° C. or higher to 100° C. or lower, more preferably 60° C. or higher to 80° C. or lower. When a heated gas is blown to heat the recording medium 1100, a gas velocity can be set to 1 m/s or more to 100 m/s or less. The temperature of wind, such as warm air, can be measured using a K-type thermocouple thermometer. A specific example of a measuring machine is a machine available under the trade name “AD-5605H” (manufactured by A&D Company, Limited).

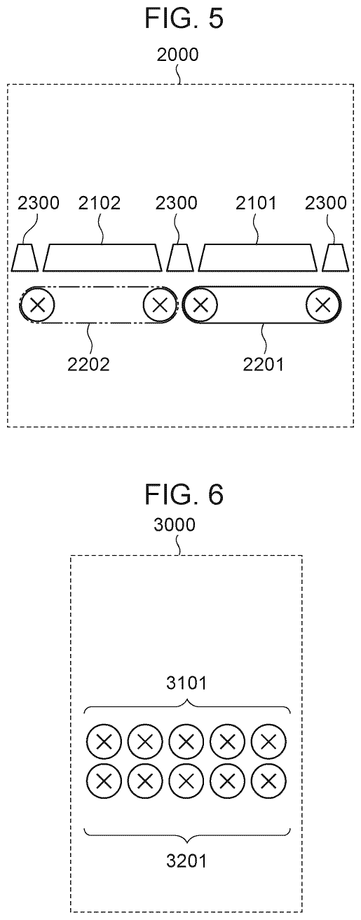

FIG. 5 is a schematic view illustrating another example of the heating portion. Here, the differences from the heating portion illustrated in FIG. 1 and described above will be described. The heating portion 2000 illustrated in FIG. 5 includes a first heating device 2101, a second heating device 2102, a first conveying member 2201 and a second conveying member 2202, the first conveying member 2201 facing the first heating device 2101, and the second conveying member 2202 facing the second heating device 2102.

The first conveying member 2201 is not provided with a mechanism for fixing the recording medium 1100 by suction. The recording medium 1100 is conveyed while pressed against the first conveying member 2201 by warm air from the first heating device 2101. Thus, the recording medium 1100 can be delivered from the conveying member 1300 (FIG. 1) to the first conveying member 2201 and from the first conveying member 2201 to the second conveying member 2202 with high accuracy. In addition, a conveyance shift due to a slight difference in conveying speed between the conveying member 1300 (FIG. 1) and the first conveying member 2201 can be reduced. Meanwhile, a conveying belt having holes that can pass a gas therethrough is used for the second conveying member 2202, and the recording medium 1100 is conveyed while fixed to the second conveying member 2202 with a suction mechanism (not illustrated).

Air knives 2300 are arranged between the conveying member 1300 (FIG. 1) and the first conveying member 2201, between the first conveying member 2201 and the second conveying member 2202 and between the second conveying member 2202 and a conveying member 3200 (FIG. 1). The lifting of the leading end portion of the recording medium 1100 conveyed is pressed down with a wind pressure from the air knives 2300. Thus, the collision of the leading end portion of the recording medium 1100 with the first heating device 2101, the second heating device 2102 and the fixing member 3100 (FIG. 1) can be avoided to inhibit the occurrence of a conveyance failure.

The first heating device 2101 and the second heating device 2102 may each have the same configuration as that of the above-mentioned heating device 2100. The first heating device 2101 and the second heating device 2102 may have the same or different temperatures. In the case of heating by blowing a heated gas, the gas velocity may be the same or different. Heating may be performed from the first conveying member 2201 and the second conveying member 2202, as needed.

### Fixing Portion

As illustrated in FIG. 1, the fixing portion 3000 is a contact-type heat and pressure-applying mechanism including the fixing member 3100 serving as a fixing belt, such as an endless belt, and the conveying member 3200. In the fixing portion 3000, the recording medium 1100 is conveyed by the conveying member 3200. The fixing member 3100 is brought into contact with the recording medium 1100 while pressure is applied to the recording medium 1100, to heat the liquids, such as the reaction liquid and the ink, applied to the recording medium 1100. Thereby, an image can be fixed to the recording medium 1100. After the liquid components of the reaction liquid and the ink permeate in the recording medium 1100 on which the image has been recorded, and evaporate as they pass through the heating portion 2000, the image are fixed in the fixing portion 3000, thereby resulting in the completion of the image. Heat and pressure are applied to the recording medium 1100 while the recording medium 1100 is interposed between the fixing member 3100 and the conveying member 3200, so that the image on the recording medium 1100 comes into close contact with the fixing member 3100, thereby fixing the image to the recording medium 1100. When a liquid, such as ink containing a resin particle and a coloring material, is used, the resin particle is softened and forms a film mainly by heating in the fixing portion 3000, and the coloring material can be bound to the recording medium 1100.

An example of a method for heating the fixing member 3100 is a method in which heating is performed by a heat source, such as a halogen heater, disposed in a roller that drives the fixing member 3100 serving as a fixing belt. A further example thereof is a method in which heating is performed by a heat source, such as an infrared heater, at a location separate from the fixing member 3100. These methods may be combined with each other. The conveying member 3200 may be heated, as needed. In consideration of the conveying speed and the environmental temperature, the temperature of the fixing member 3100 can be set in such a manner that the surface of the recording medium has a desired temperature. Specifically, the temperature of the fixing member 3100 is preferably 50° C. or higher to 120° C. or lower, more preferably 60° C. or higher to 110° C. or lower. The temperature of the contact-type heat and pressure-applying mechanism (fixing member 3100) and the surface temperature of the recording medium immediately after passing through the contact-type heat and pressure-applying mechanism can both be measured using a radiation thermometer. The radiation thermometer is only required to be disposed near an end portion (terminal) of the contact-type heat and pressure-applying mechanism. A specific example of the radiation thermometer is a thermometer available under the trade name “Radiation Thermometer IT-545S” (manufactured by Horiba, Ltd.).

When the ink contains a resin particle, a temperature of the fixing member 3100 higher than or equal to the glass transition temperature of the resin particle in the ink can result in softening of the resin particle to easily form a film, thereby improving the abrasion resistance of the image. When the ink contains a wax particle, the temperature of the fixing member 3100 can be lower than the melting point of the wax constituting the wax particle. This enables the wax that is inhibited from melting easily to remain on the surface of the image more easily, thereby improving the abrasion resistance of the image.

A nip pressure between the fixing member 3100 and the conveying member 3200, that is, a pressure applied to the recording medium when the medium passes through the contact-type heat and pressure-applying mechanism is preferably 10 Pa or more to 1,000 Pa or less, more preferably 10 Pa or more to 500 Pa or less. The pressure is particularly preferably 10 Pa or more to 400 Pa or less.

The time period (nip time) required for the recording medium to pass through the contact-type heat and pressure-applying mechanism is preferably 0.25 seconds or more to 5.0 seconds or less, more preferably 0.5 seconds or more to 4.0 seconds or less, and particularly preferably 1.0 second or more to 3.0 seconds or less.

FIG. 6 is a schematic view illustrating another example of the fixing portion. Here, the differences from the fixing portion illustrated in FIG. 1 and described above will be described. The fixing portion 3000 illustrated in FIG. 6 is a contact-type heat and pressure-applying mechanism including a plurality of fixing rollers 3101 and a plurality of conveying members 3201 facing these fixing rollers 3101. The recording medium 1100 to which a liquid such as ink has been applied passes between the fixing rollers 3101 and the conveying members 3201, thereby fixing an image to the recording medium. It is possible to adjust the extent to which the image is fixed to the recording medium by controlling the number of fixing rollers 3101, the number of conveying members 3201, the nip time of the recording medium, the temperature, the pressure and so forth.

### Cooling Portion

The cooling portion 4000 includes the cooling member 4100 and a conveying member 4200 (FIG. 1). The cooling portion 4000 cools the recording medium 1100 that has passed through the heating portion 2000 and the fixing portion 3000 to have a high temperature. The cooling member 4100 may have any configuration as long as it can cool the recording medium 1100, and methods such as air cooling and water cooling can be used. In particular, blowing an unheated gas can be performed from the viewpoint of safety and energy efficiency. To jet a gas to the recording medium 1100, the use of a mechanism for blowing a gas with a built-in fan easily improves the cooling efficiency. In view of the conveying speed and the environmental temperature, the temperature of a cooling unit can be set in such a manner that the recording medium has a desired temperature. Specifically, the temperature of the cooling unit, such as an air blower, is preferably 20° C. or higher to 60° C. or lower, more preferably 25° C. or higher to 50° C. or lower. When cooling is performed by blowing a gas, the gas velocity can be 1 m/s or more to 100 m/s or less. The use of the conditions can inhibit the deformation of the recording medium 1100 to be stacked in the sheet delivery portion 6000 described below and the image sticking (blocking).

### Reversing Portion

When double-sided recording is performed, the recording medium 1100 is reversed by the use of the reversing portion 5000 (FIG. 1). The recording medium 1100 having an image recorded on its recording surface (front surface) passes through the cooling portion 4000, is then conveyed to a branch line, and reversed by the reversing device 5100. The recording medium 1100 that has been reversed is conveyed to the sheet feeding device 1400 of the recording portion 1000 in such a manner that the liquids can be applied to its rear surface, which is a surface opposite to the recording surface (front surface).

### Sheet Delivery Portion

The recording medium 1100 after the image recording is stored in the sheet delivery portion 6000 (FIG. 1). The recording medium 1100 is subjected to single-sided recording or double-sided recording, and then passes through the cooling portion 4000, is conveyed by the conveying member 6100 and finally stored in a stacked state in the recording medium storage portion 6200. Two or more recording medium storage portions 6200 may be arranged for, for example, separately storing different recorded articles.

### Reaction Liquid

The recording method according to an embodiment of the present invention includes the reaction liquid applying step of applying the aqueous reaction liquid containing the reactant that reacts with the aqueous ink to the recording medium. In particular, the reaction liquid applying step can be performed before the ink applying step. Components and so forth used in the reaction liquid will be described in detail below.

### Reactant

The reaction liquid reacts with the ink when the reaction liquid comes into contact with the ink, to allow a component, such as a component having an anionic group, e.g., a resin, a surfactant or a self-dispersible pigment, in the ink to aggregate, and contains a reactant. As the reactant, a cationic resin is contained.

### Cationic Resin

As described above, the cationic resin contains, in the molecular weight distribution measured by gel permeation chromatography (GPC), the first cationic resin having a peak in a molecular weight range of 100,000 or more to 500,000 or less, and the second cationic resin having a peak in a molecular weight range of 2,000 or more to less than 100,000.

The second cationic resin can have a peak in a molecular weight range of 10,000 or more to less than 100,000 in the molecular weight distribution measured by GPC. When the peak position measured by GPC is 10,000 or more, the generation of a satellite droplet can be further inhibited to thereby further inhibit image fading. When the peak position measured by GPC is less than 100,000, the viscosity in the discharge port after a stop for a certain period of time does not excessively increase, and thus the discharge of the reaction liquid at the start of recording can be improved.

The molecular weight distribution of the cationic resin may be determined by directly measuring the cationic resin using GPC before the reaction liquid is prepared, or may be determined from the prepared reaction liquid. When the molecular weight distribution of the cationic resin is measured from the prepared reaction liquid by GPC, the measurement is performed as follows: The reaction liquid containing the cationic resin is used as a sample, and the molecular weight distribution is measured using GPC in the same manner as in the case of directly measuring the cationic resin. In the resulting molecular weight distribution, substances contained in respective molecular weight ranges are fractionated to separate substances having different molecular weights. The mass ratio of each molecular weight substance is determined from the area (peak area) of each molecular weight range in the resulting molecular weight distribution. The structures of the separated substances are identified using a nuclear magnetic resonance (NMR) spectrometer. In this manner, the structures and amounts of the cationic resins having molecular weight distributions in the reaction liquid can be determined.

It is important that the mass ratio of the second cationic resin content (% by mass) to the first cationic resin content (% by mass) be 0.01 times or more to 8.0 times or less. To further improve the inhibition of image unevenness at the recording start portion and the inhibition of image fading, the mass ratio of the second cationic resin content (% by mass) to the first cationic resin content (% by mass) can be 0.01 times or more to 0.30 times or less.

Examples of cationic resins include resins having a primary, secondary or tertiary amine structure, and resins having a quaternary ammonium salt structure. Specific examples thereof include resins having structures of, for example, vinylamine, allylamine, vinylimidazole, vinylpyridine, dimethylaminoethyl methacrylate, ethyleneimine, guanidine, diallyldimethylammonium chloride and alkylamine-epichlorohydrin condensates. To improve the solubility in the reaction liquid, a cationic resin may be used in combination with an acidic compound, or the cationic resin may be subjected to quaternization treatment. When a cationic resin is used as the reactant, the cationic resin content (% by mass) of the reaction liquid can be 0.1% by mass or more to 10.0% by mass or less based on the total mass of the reaction liquid.

The counter anion of the cationic group of the cationic resin can be a chloride ion.

This is presumably because the chloride ion has a small ion size as compared with, for example, an ethyl sulfate ion, which is a general-purpose counter anion of the cationic group, and thus is less likely to inhibit the interaction between the cationic group and the anionic component in the ink. This can further improve color developability. The reaction liquid may contain an ethyl sulfate ion and the like in addition to a chloride ion derived from a counter anion.

Each of the first cationic resin and the second cationic resin can have a quaternary ammonium salt structure. When the cationic resin has a quaternary ammonium salt structure, a quaternary ammonium ion is contained as the cationic group of the cationic resin. The cationic resin can stably retain its cationicity when the cationic resin comes into contact with the ink and thus the cationic resin is more likely to interact with an anionic component in the ink.

The first cationic resin and the second cationic resin can have an identical repeating structural unit (that is, they have only the same repeating structural unit). When the identical repeating structural unit is used, association due to the formation of a hydrogen bond between the cationic resin molecules is facilitated to improve the spinnability of the droplet of the reaction liquid. This can inhibit the droplet from breaking, thereby reducing image fading.

Each of the first cationic resin and the second cationic resin can be a polymer having a repeating structural unit represented by the following general formula (1):

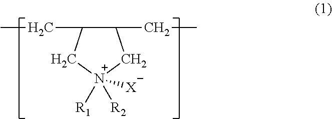

where R₁ and R₂ are each independently an alkyl group, and X⁻ is a counter anion of a quaternary ammonium cation.

The repeating structural unit can be a diallyldimethylammonium chloride structure in which R₁ and R₂ in formula (1) described above are each a methyl group. The diallyldimethylammonium chloride structure has a quaternary ammonium salt in the side chain of the resin. This structure is less susceptible to steric hindrance than when a quaternary ammonium salt is in the main chain. For this reason, the cationic resin easily interacts with the anion component in the ink, thereby improving the effect of inhibiting image unevenness.

In addition to the above-described cationic resin, a polyvalent metal salt or an organic acid may be used as a reactant. In particular, the polyvalent metal salt can be used together with the cationic resin.

In the case of using a combination of the cationic resin and the polyvalent metal salt, when the reaction liquid and the ink come into contact on a recording medium, the polyvalent metal ion dissociated from the polyvalent metal salt has a faster diffusion rate than the cationic resin and thus quickly react with the anionic component in the ink, thereby promoting aggregation. Furthermore, the cationic resin reacts with the aggregates so as to surround them, resulting in larger aggregates. Therefore, the permeation of the coloring material into the interior of the recording medium can be inhibited, thereby inhibiting image unevenness.

The polyvalent metal salt is a compound composed of a di- or higher-valent metal ion (polyvalent metal ion) and an anion. The polyvalent metal salt dissociates in the reaction liquid to form a polyvalent metal ion, which aggregates an anionic component, such as a pigment dispersed by an anionic group in the ink. The polyvalent metal salt may be a hydrate. Examples of the polyvalent metal ion constituting the polyvalent metal salt include divalent metal ions, such as Ca²⁺, Cu²⁺, Ni²⁺, Mg²⁺, Sr²⁺, Ba²⁺ and Zn²⁺; and trivalent metal ions, such as Fe³⁺, Cr³⁺, Y³⁺ and Al³⁺. Examples of the anion include inorganic anions, such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄^{2—} and H₂PO₄⁻; and organic anions, such as HCOO⁻, (COO⁻)₂, COOH(COO⁻), CH₃COO⁻, CH₃CH(OH)COO⁻, C₂H₄ (COO⁻)₂, C₆H₅COO⁻, C₆H₄(COO⁻)₂ and CH₃SO₃⁻. When a polyvalent metal ion is used as the reactant, the content (% by mass) in terms of a polyvalent metal salt in the reaction liquid can be 1.0% by mass or more to 20.0% by mass or less based on the total mass of the reaction liquid. In the present specification, when the polyvalent metal salt is a hydrate, the term “polyvalent metal salt content (% by mass)” in the reaction liquid refers to the “anhydrous polyvalent metal salt content (% by mass)” excluding water in the hydrate.

The reaction liquid containing an organic acid has a buffering capacity in the acidic region (a pH of less than 7.0, such as a pH of 2.0 or more to 5.0 or less) and thus efficiently converts the anionic group of the component present in the ink into an acid form, thereby allowing them to aggregate. Examples of the organic acid include monocarboxylic acids and salts thereof, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid; dicarboxylic acids and salts and hydrogen salts thereof, such as oxalic acid, malonic acid, succinic acid, glutaric acid, adipic acid, maleic acid, fumaric acid, itaconic acid, sebacic acid, phthalic acid, malic acid and tartaric acid; tricarboxylic acids and salts and hydrogen salts thereof, such as citric acid and trimellitic acid; and tetracarboxylic acids and salts and hydrogen salts thereof, such as pyromellitic acid. When an organic acid is used as the reactant, the organic acid content (% by mass) of the reaction liquid can be 1.0% by mass or more to 50.0% by mass or less based on the total mass of the reaction liquid.

### Aqueous Medium

The reaction liquid is an aqueous reaction liquid containing at least water as an aqueous medium. Examples of the aqueous medium for use in the reaction liquid include the same ones as the aqueous medium which can be contained in the ink, which will be described below. The aqueous medium for use in the reaction liquid may contain a water-soluble organic solvent, which will be described below and which can be contained in the ink. The water-soluble organic solvent content (% by mass) of the reaction liquid can be 1.0% by mass or more to 45.0% by mass or less based on the total mass of the reaction liquid. The water-soluble organic solvent can contain a specific water-soluble hydrocarbon compound described below. The water-soluble hydrocarbon compound content (% by mass) of the reaction liquid can be 1.0% by mass or more to 20.0% by mass or less based on the total mass of the reaction liquid. The water content (% by mass) of the reaction liquid can be 50.0% by mass or more to 95.0% by mass or less based on the total mass of the reaction liquid.

### Other Components

The reaction liquid may contain various other components as needed. Examples of the other components include the same other components that can be contained in the ink, which will be described below.

### Physical Properties of Reaction Liquid

The reaction liquid is an aqueous reaction liquid for use in the ink jet method. Thus, from the viewpoint of reliability, the physical property values of the reaction liquid can be appropriately controlled. Specifically, the static surface tension of the reaction liquid at 25° C. can be 20 mN/m or more to 60 mN/m or less. The dynamic surface tension of the reaction liquid can be 40 mN/m or less at a lifetime of 10 ms. The lower limit of this dynamic surface tension is not limited to a particular value. For example, the lower limit can be 25 mN/m or more.

The dynamic surface tension of the reaction liquid at a lifetime of 10 ms can be measured by a maximum bubble pressure method. The maximum bubble pressure method is a method in which the maximum pressure required to release a bubble formed at the tip of a probe (capillary) immersed in a target liquid for measurement is measured and in which the surface tension of the liquid is determined from the resulting maximum pressure. The lifetime in the maximum bubble pressure method is the time from when the surface of a new air bubble is formed at the tip of the probe to when the maximum bubble pressure (the point of time when the radius of curvature of the air bubble is equal to the radius of the tip portion of the probe) is reached. The dynamic surface tension of the ink in this specification is a value measured at 25° C.

The viscosity of the reaction liquid at 25° C. is preferably 1.0 mPa·s or more to 10.0 mPa·s or less, more preferably 1.5 mPa·s or more to 5.0 mPa·s or less. When the viscosity is 1.5 mPa·s or more, the generation of a satellite droplet can be further inhibited, thereby improving image fading. When the viscosity is 5.0 mPa·s or less, the viscosity in the discharge port after a stop for a certain period of time does not excessively increase. Thus, the reaction liquid is easily discharged at the start of recording, and image unevenness is less likely to occur.

The pH of the reaction liquid at 25° C. is preferably 5.0 or more to 9.5 or less, more preferably 6.0 or more to 9.5 or less.

### Ink

The ink used in the recording method according to an embodiment of the present invention is an aqueous ink for ink jet recording. Components and so forth used for the ink will be described in detail below.

### Coloring Material

The ink can contain a coloring material. As the coloring material, a pigment or a dye can be used. The coloring material content (% by mass) of the ink is preferably 0.5% by mass or more to 15.0% by mass or less, more preferably 1.0% by mass or more to 10.0% by mass or less, based on the total mass of the ink.

Specific examples of the pigment include inorganic pigments, such as carbon black and titanium oxide; and organic pigments, such as azo, phthalocyanine, quinacridone, isoindolinone, imidazolone, diketopyrrolopyrrole and dioxazine. The pigments may be used alone or in combination of two or more.

With regard to a method for dispersing the pigment, a resin-dispersed pigment using a resin as a dispersant, or a self-dispersible pigment in which a hydrophilic group is bonded to the surface of a pigment particle can be used. A resin-bonded pigment in which a resin-containing organic group is chemically bonded to the surface of a pigment particle, and a microencapsulated pigment in which the surface of a pigment particle is coated with a resin or the like can also be used. It is also possible to use a combination of these pigments having different dispersion methods. In particular, a resin-dispersed pigment in which a resin serving as a dispersant is physically adsorbed onto the surface of a pigment particle can be used, rather than a resin-bonded pigment or a microencapsulated pigment.

As a resin dispersant for dispersing a pigment in an aqueous medium, a dispersant that can disperse a pigment in an aqueous medium by the action of an anionic group can be used. As a resin dispersant, a resin having an anionic group can be used, and a resin as described below, particularly a water-soluble resin, can be used. The pigment content (% by mass) of the ink can be 0.3 to 10.0 times the resin dispersant content (% by mass) in terms of mass ratio.

As the self-dispersible pigment, it is possible to use a pigment in which an anionic group, such as a carboxylic acid group, a sulfonic acid group or a phosphonic acid group, is bonded to the surface of a pigment particle directly or with another atomic group (—R—) interposed therebetween. The anionic group may be in an acid form or a salt form. When the anionic group is in a salt form, the anionic group may be in a partially dissociated state or a completely dissociated state. When the anionic group is in a salt form, examples of a cation serving as a counter ion include an alkali metal cation, ammonium and organic ammonium. Specific examples of the other atomic group (—R—) include linear or branched alkylene groups having 1 to 12 carbon atoms; arylene groups, such as a phenylene group and a naphthylene group; carbonyl groups; imino groups; amide groups; sulfonyl groups; ester groups; and ether groups. It may also be a combination of these groups.

A dye having an anionic group can be used. Specific examples of the dye include azo, triphenylmethane, (aza) phthalocyanine, xanthene and anthrapyridone dyes. These dyes may be used alone or in combination of two or more. The coloring material can be a pigment, such as a resin-dispersed pigment or a self-dispersible pigment.

### Resin

The ink can contain a resin. The use of a resin-containing ink makes it possible to record an image having improved abrasion resistance. The resin can be added to the ink in order to (i) stabilize the dispersion state of the pigment, that is, the resin can be added as a resin dispersant or its aid.

The resin can also be added to the ink in order to (ii) improve various characteristics of the image to be recorded.

The resin content (% by mass) of the ink is preferably 0.1% by mass or more to 20.0% by mass or less, more preferably 0.5% by mass or more to 15.0% by mass or less, based on the total mass of the ink. Examples of the form of the resin include a block copolymer, a random copolymer, a graft copolymer and a combination thereof. The resin may be a water-soluble resin that can be dissolved in an aqueous medium, or may be a resin particle that is dispersed in an aqueous medium. These resins may be used alone or in combination of two or more.

### Composition of Resin

Examples of the resin include an acrylic resin, a urethane-based resin and an olefin-based resin. Among them, an acrylic resin and a urethane-based resin can be used, and an acrylic resin composed of units derived from (meth)acrylic acid or (meth)acrylate can be used.

An acrylic resin having a hydrophilic unit and a hydrophobic unit as constituent units can be used as the acrylic resin. Among them, a resin having a hydrophilic unit derived from (meth)acrylic acid and a hydrophobic unit derived from at least one of a monomer having an aromatic ring and a (meth)acrylic acid ester monomer can be used. In particular, a resin having a hydrophilic unit derived from (meth)acrylic acid and a hydrophobic unit derived from at least one monomer selected from styrene and α-methylstyrene can be used. These resins easily interact with pigments, and thus can be used as resin dispersants for dispersing pigments.

The hydrophilic unit is a unit having a hydrophilic group such as an anionic group. The hydrophilic unit can be formed, for example, by polymerizing a hydrophilic monomer having a hydrophilic group. Specific examples of the hydrophilic monomer having a hydrophilic group include acidic monomers having a carboxylic acid group, such as (meth)acrylic acid, itaconic acid, maleic acid and fumaric acid; and anionic monomers, such as anhydrides and salts of these acidic monomers. Examples of a cation constituting the salt of the acidic monomer include a lithium ion, a sodium ion, a potassium ion, an ammonium ion and organic ammonium ion. The hydrophobic unit is a unit having no hydrophilic group, such as an anionic group. The hydrophobic unit can be formed, for example, by polymerizing a hydrophobic monomer having no hydrophilic group, such as an anionic group. Specific examples of the hydrophobic monomer include monomers having an aromatic ring, such as styrene, α-methylstyrene and benzyl (meth)acrylate; and (meth)acrylic acid ester monomers, such as methyl (meth)acrylate, butyl (meth)acrylate and 2-ethylhexyl (meth)acrylate.

The urethane-based resin can be prepared, for example, by reacting a polyisocyanate with a polyol. The urethane-based resin may also be one that has been reacted with a chain extender. Examples of the olefin-based resin include polyethylene and polypropylene.

### Resin Properties

In the present specification, the expression “a resin is water-soluble” indicates that when the resin is neutralized with an alkali equivalent to the acid value, the resin is present in an aqueous medium in a state in which the resin is not in the form of a particle having a particle size that can be measured by a dynamic light scattering method. Whether a resin is water-soluble can be determined according to a method described below. First, a liquid (resin solid content: 10% by mass) containing a resin neutralized with an alkali, such as sodium hydroxide or potassium hydroxide, equivalent to its acid value is prepared. Subsequently, the prepared liquid is diluted 10 times (on a volume basis) with pure water to prepare a sample solution.

Then, in the case where the particle size of the resin in the sample solution is measured by the dynamic light scattering method and where a particle having a particle size is not measured, the resin can be determined to be water-soluble. The measurement conditions at this time can be as follows: for example, SetZero: 30 seconds; the number of times of measurement: 3 times; and measurement time: 180 seconds. A particle size analyzer based on the dynamic light scattering method (e.g., trade name: “UPA-EX150”, manufactured by Nikkiso Co., Ltd.) or the like may be used as a particle size distribution measurement apparatus.

Of course, the particle size distribution measurement apparatus, the measurement conditions and so forth are not limited to the foregoing.

The acid value of the water-soluble resin can be 100 mgKOH/g or more to 250 mgKOH/g or less. The weight-average molecular weight of the water-soluble resin can be 3,000 or more to 15,000 or less.

The acid value of the resin constituting the resin particle can be 5 mgKOH/g or more to 100 mgKOH/g or less. The weight-average molecular weight of the resin constituting the resin particle is preferably 1,000 or more to 3,000,000 or less, more preferably 100,000 or more to 3,000,000 or less. The 50% cumulative particle size (D₅₀) of the resin particle measured by a dynamic light scattering method on a volume basis can be 50 nm or more to 500 nm or less. The 50% cumulative particle size of the resin particle on a volume basis is a diameter of a particle at which the cumulative value from the small particle size side reaches 50% based on the total volume of the measured particle in a particle size cumulative curve. The 50% cumulative particle size of the resin particle on a volume basis can be measured based on the particle size analyzer and the measurement conditions by the dynamic light scattering method described above. The glass transition temperature of the resin particle is preferably 40° C. or higher to 120° C. or lower, more preferably 50° C. or higher to 100° C. or lower. The glass transition temperature (° C.) of the resin particle can be measured with a differential scanning calorimeter (DSC). The resin particle does not need to contain a coloring material.

### Wax Particle

The ink may contain a particle composed of wax (wax particle).

The use of the ink containing the wax particle can record an image having further improved abrasion resistance. The wax in the present specification may be a composition in which a component other than the wax is blended, or may be the wax itself. The wax particle may be dispersed by a dispersant, such as a surfactant or a resin. One type of wax may be used alone, or two or more types of waxes may be used in combination. The wax particle content (% by mass) of the ink is preferably 0.1% by mass or more to 10.0% by mass or less, more preferably 1.0% by mass or more to 5.0% by mass or less, based on the total mass of the ink.

In a narrow sense, the wax is an ester of a fatty acid with a higher monohydric alcohol or dihydric alcohol insoluble in water, and includes an animal wax and a vegetable wax but includes no oil or fat. In a broad sense, the wax includes a high-melting-point fat, a mineral-based wax, a petroleum-based wax and a blend and a modified product of various waxes. According to an embodiment of the present invention, any wax in a broad sense can be used without particular limitation. The wax in a broad sense can be classified into natural wax, synthetic wax, a blend thereof (blended wax) and a modified product thereof (modified wax).

Examples of the natural wax include animal-based wax, such as beeswax, spermaceti, or wool wax (lanolin); plant-based wax, such as Japan wax, carnauba wax, sugarcane wax, palm wax, candelilla wax, or rice wax; mineral-based wax, such as montan wax; and petroleum-based wax, such as paraffin wax, microcrystalline wax and petrolatum. Examples of the synthetic wax include hydrocarbon wax, such as Fischer-Tropsch wax and polyolefin wax, e.g., polyethylene wax and polypropylene wax. The blended wax is a mixture of the various waxes described above. The modified wax is prepared by subjecting the above-described various waxes to modification treatment, such as oxidation, hydrogenation, alcohol modification, acrylic modification or urethane modification. These waxes may be used alone or in combination of two or more. The wax can be at least one selected from the group consisting of microcrystalline wax, Fischer-Tropsch wax, polyolefin wax, paraffin wax, modified products thereof and blends thereof. Among these, a blend of a plurality of waxes can be used. A blend of petroleum-based wax and synthetic wax can be used.

The wax can be solid at room temperature (25° C.). The melting point (° C.) of the wax is preferably 40° C. or higher to 120° C. or lower, more preferably 50° C. or higher to 100° C. or lower. The melting temperature of the wax can be determined in accordance with a test method described in 5.3.1 (testing method for melting point) of JIS K 2235:1991 (Petroleum waxes). For microcrystalline wax, petrolatum and a mixture of a plurality of waxes, the melting point can be more accurately measured by a test method described in 5.3.2. The melting point of the wax is easily affected by properties, such as molecular weight (a higher molecular weight results in a higher melting point), molecular structure (a linear structure has a high melting point, and a branched structure has a lower melting point), crystallinity (a high crystallinity results in a higher melting point) and density (a higher density results in a higher melting point). Thus, wax having a desired melting point can be produced by controlling these properties. The melting point of the wax in the ink can be determined by, for example, subjecting the ink to ultracentrifugation treatment, washing and drying the separated wax, and then performing measurement in accordance with the above-described test method.

### Aqueous Medium

The ink used in the recording method according to an embodiment of the present invention is an aqueous ink containing at least water as the aqueous medium. The ink can contain water or an aqueous medium that is a mixed solvent of water and a water-soluble organic solvent. Deionized water or ion-exchanged water can be used as the water.

The water content (% by mass) of the aqueous ink can be 50.0% by mass or more to 95.0% by mass or less based on the total mass of the ink. The water-soluble organic solvent content (% by mass) of the aqueous ink can be 2.0% by mass or more to 40.0% by mass or less based on the total mass of the ink. Examples of the water-soluble organic solvent include alcohol, (poly)alkylene glycol, glycol ether, a nitrogen-containing solvent and a sulfur-containing solvent, which can be used in an ink for ink jet recording. These water-soluble organic solvents may be used alone or in combination of two or more.

### Water-Soluble Hydrocarbon Compound

The water-soluble organic solvent incorporated into the ink can contain a specific water-soluble hydrocarbon compound. This water-soluble hydrocarbon compound is a compound that has a hydrocarbon chain having 3 or more carbon atoms and that is substituted with 2 or more hydrophilic groups selected from the group consisting of a hydroxy group, an amino group and an anionic group. However, the hydrocarbon chain may be interrupted by a sulfonyl group or an ether group. When the hydrocarbon chain has 3 or 4 carbon atoms, the hydrophilic group contains an anionic group or the hydrocarbon chain is interrupted by a sulfonyl group.

In an embodiment of the present invention, a hydrocarbon compound in the state of being dissolved in water at a compound content of the ink at 25° C. is defined as being “water-soluble”. That is, the solubility of the compound in water at 25° C. is larger than the compound content of the ink. The fact that the hydrocarbon chain is interrupted by a sulfonyl group or an ether group indicates that a sulfonyl group (—S(═O)₂—) or an ether group (—O—) is present in the middle of the hydrocarbon chain. The water-soluble hydrocarbon compound has a hydrogen-bonding group, such as a hydroxy group, an amino group, an anionic group, a sulfonyl group or an ether group. For this reason, the use of the ink containing the hydrocarbon compound can inhibit the cockling or curl of a recording medium on which an image has been recorded. A typical hydrocarbon compound having a hydrocarbon chain having a relatively small number of carbon atoms (3 or 4 carbon atoms) has a small molecular weight and tends to have a low vapor pressure. However, since the above-mentioned water-soluble hydrocarbon compound has a hydrogen-bonding anionic group or its hydrocarbon chain is interrupted by a sulfonyl group, the compound is less likely to evaporate owing to an intermolecular or intramolecular interaction and thus remains between fibers to provide the effect of inhibiting the cockling or curl. The water-soluble hydrocarbon compound content (% by mass) of the ink can be 1.0% by mass or more to 20.0% by mass or less based on the total mass of the ink.

The number of the carbon atoms of the hydrocarbon chain constituting the water-soluble hydrocarbon compound is preferably 3 or more to 50 or less, more preferably 3 or more to 10 or less. Examples of the anionic group include a sulfonic acid group and a carboxylic acid group. Specific examples of the water-soluble hydrocarbon compound include alkanediols, such as 1,5-pentanediol and 1,6-hexanediol; amino acids, such as alanine, β-alanine, trimethylglycine, amidosulfuric acid (alias: sulfamic acid), aminomethanesulfonic acid, taurine (synonym: 2-aminoethanesulfonic acid), carbamic acid, glycine, aspartic acid, glutamic acid, sulfanilic acid, salts of the acids described above, phenylalanine, leucine, isoleucine, threonine, tryptophan, valine, methionine, lysine and arginine; sulfonyl compounds, such as bis(2-hydroxyethyl) sulfone; alkylene glycols, such as triethylene glycol, tetraethylene glycol, tripropylene glycol and a polyethylene glycol having a number-average molecular weight of about 200 or more to about 1,000 or less; and sugars, such as sorbitol, D-sorbitol, xylitol, trehalose, fructose and D (+)-xylose. These water-soluble hydrocarbon compounds may be used alone or in combination two or more.

### Other Components

The ink may contain various other components as needed. Examples of the other components include various additives, such as a defoaming agent, a surfactant, a pH adjuster, a viscosity modifier, a rust inhibitor, a preservative, an antifungal agent, an antioxidant, and a reduction inhibitor. However, the ink need not contain the reactant contained in the reaction liquid.

### Physical Properties of Ink

The ink is an aqueous ink for use in the ink jet method. Thus, from the viewpoint of reliability, the physical property values can be appropriately controlled. The surface tension of the ink at 25° C. can be 20 mN/m or more to 60 mN/m or less. The viscosity of the ink at 25° C. can be 1.0 mPa·s or more to 10.0 mPa·s or less. The pH of the ink at 25° C. is preferably 7.0 or more to 9.5 or less, more preferably 8.0 or more to 9.5 or less.

According to an embodiment of the present invention, it is possible to provide an ink jet recording method by which image unevenness can be inhibited when an ink and a reaction liquid are applied to a recording medium by discharging the ink and the reaction liquid from ink jet recording heads to record an image, by which image fading can be inhibited when images are continuously recorded and by which image unevenness at a recording start portion can be inhibited when the image is recorded after a stop for a certain period of time. According to an embodiment of the present invention, it is also possible to provide an ink jet recording apparatus and a set of an aqueous ink and an aqueous reaction liquid for use in the ink jet recording method.

### EXAMPLES

While the present invention will be described in more detail with reference to examples and comparative examples, the present invention is not limited at all by the following examples as long as the gist of the present invention is not exceeded. Regarding the amount of component, “part(s)” and “%” are based on mass unless otherwise specified.

The trade names of cationic resins used in examples and comparative examples and the molecular weights at peak positions in the molecular weight distributions of the cationic resins measured by gel permeation chromatography (GPC) are described below. The GPC measurement conditions are also described below.

Trade Name of Cationic Resin and Molecular Weight at Peak Position in Molecular Weight Distribution Measured by GPC
PAS-H-5L: diallyldimethylammonium chloride polymer (manufactured by Nittobo Medical Co., Ltd.) (quaternary ammonium salt, concentration: 28%, molecular weight at peak position by GPC: 30,000)
PAS-J-81L: diallyldimethylammonium chloride-acrylamide copolymer (manufactured by Nittobo Medical Co., Ltd.) (quaternary ammonium salt, concentration: 25%, molecular weight at peak position by GPC: 10,000)
Catiomaster PE-30: (manufactured by Yokkaichi Chemical Co., Ltd.) (dimethylamine-ethylenediamine-epichlorohydrin resin, concentration: 50%, molecular weight at peak position by GPC: 9,000)
PAA-HCL-3L: allylamine hydrochloride polymer (manufactured by Nittobo Medical Co., Ltd.) (primary amine, concentration: 50%, molecular weight at peak position by GPC: 15,000)
PAA-HCL-10L: allylamine hydrochloride polymer (manufactured by Nittobo Medical Co., Ltd.) (primary amine, concentration: 28%, molecular weight at peak position by GPC: 100,000)
EPA-SK01: polyamidepolyamine-epichlorohydrin condensation-type resin (manufactured by Yokkaichi Chemical Co., Ltd.) (tertiary amine, concentration: 12.5%, molecular weight at peak position by GPC: 200,000 or more)

### Measurement Conditions for Gel Permeation Chromatography (GPC)

Measuring device: Molecular weight measuring device (trade name: “Waters ALLIANCE e2695”, manufactured by Waters)
Columns: Asahipak “GF-310”, Asahipak “GF-510” (these are trade names, manufactured by Showa Denko K.K.)
Eluent: Mixture of 0.5 mmol/L aqueous solution of acetic acid and 0.1 mmol/L aqueous solution of sodium nitrate
Flow rate: 1.0 mL/min
Oven temperature: 40° C.
Detector: differential refractive index (RI) detector (trade name: “Wyatt Optilab rEX Refractive Index Detector”, manufactured by Wyatt Technology)

In the calculation of the molecular weight, a molecular weight calibration curve produced by using a molecular weight standard (trade name “EasiCal Type PS-2 polystyrene”, manufactured by Agilent Technologies, Inc.) was used.

When the cationic resin was fractionated from the prepared reaction liquid, the molecular weight at the peak position in the molecular weight distribution by GPC was the same as that of the cationic resin before the preparation of the reaction solution.

### Preparation of Cationic Resin

### Aqueous Solution of Cationic Resin A

Into a four-necked flask equipped with a thermometer, a stirring rod and a reflux condenser, 161.67 parts of a 60% by mass aqueous solution of diallyldimethylammonium chloride (trade name: DADMAC, manufactured by Tokyo Chemical Industry Co., Ltd.), 1.46 parts of sodium hypophosphite serving as a “chain transfer agent” and 32.3 parts of pure water were charged. The mixture was heated to 60° C., and then 0.39 parts of ammonium persulfate serving as a “polymerization initiator” was added thereto. The mixture was heated for 10 hours while the temperature was maintained at 60° C. to carry out the reaction, thereby preparing cationic resin A. Pure water was then added to prepare an aqueous solution of cationic resin A with a concentration of 20%. The molecular weight of cationic resin A at the peak position in the molecular weight distribution measured by gel permeation chromatography (GPC) was 2,000.

### Aqueous Solutions of Cationic Resins B to J

Aqueous solutions of cationic resins B to J were prepared in the same manner as in the preparation of the aqueous solution of cationic resin A, except that the amounts of DADMAC, sodium hypophosphite, ammonium persulfate and water added were as presented in Table 1. The GPC peak positions of cationic resins B to J are presented in Table 1.

### Table 1

TABLE 1
Synthesis conditions and characteristics of cationic resins A to J

| | | Sodium | Ammonium | | Total | Molecular |
|---|---|---|---|---|---|---|
| Cationic | DADMAC | hypophosphite | persulfate | Water | amount | weight at |
| resin | (part) | (part) | (part) | (part) | (part) | peak position |
| A | 80.84 | 0.73 | 0.20 | 18.23 | 100 | 2000 |
| B | 80.84 | 0.22 | 0.20 | 18.74 | 100 | 90000 |
| C | 80.84 | 0.50 | 0.20 | 18.46 | 100 | 9500 |
| D | 80.84 | 0.48 | 0.20 | 18.48 | 100 | 10000 |
| E | 80.84 | 0.20 | 0.20 | 18.76 | 100 | 100000 |
| F | 80.84 | 0.12 | 0.20 | 18.84 | 100 | 200000 |
| G | 80.84 | 0.01 | 0.20 | 18.95 | 100 | 500000 |
| H | 80.84 | 0.20 | 0.20 | 18.76 | 100 | 110000 |
| I | 80.84 | 0.01 | 0.20 | 18.95 | 100 | 550000 |
| J | 80.84 | 0.75 | 0.20 | 18.21 | 100 | 1500 |

### Aqueous Solution of Cationic Resin K

To 550 g of 35% hydrochloric acid, 286 g of monoallylamine was added dropwise while stirring at 5° C. to 10° C. under ice cooling. After the dropwise addition, water and hydrogen chloride were removed at 60° C. under reduced pressure with a rotary evaporator to give a white crystal. The resulting crystal was dried at 80° C. under reduced pressure to give 485 g of monoallylamine hydrochloride. A 70% aqueous solution of the resulting monoallylamine hydrochloride was prepared. In 50 g of the aqueous solution, 2,2′-azobis (2-amidinopropane) dihydrochloride, serving as a radical initiator, was dissolved in an amount of 1% by mole based on the monoallylamine hydrochloride. Then 25 g of 35% hydrochloric acid was added thereto. The mixture was subjected to static polymerization at 60° C. for 40 hours. After the polymerization was completed, the system was poured into a mixed solution of 1,900 g of acetone/100 g of methanol, and the resulting precipitate was filtered to give polyallylamine hydrochloride. The resulting polyallylamine hydrochloride was dissolved in pure water to prepare a 40% aqueous solution. Hydrochloric acid was removed using ion-exchange resin IRA900 (trade name, manufactured by Organo Corporation) that had been previously ion-exchanged with sodium hydroxide, thereby preparing cationic resin K, which was a polyallylamine. Thereafter, pure water was added to prepare an aqueous solution of cationic resin K with a concentration of 40%. The molecular weight of cationic resin K at the peak position in the molecular weight distribution measured by gel permeation chromatography (GPC) was 2,000.

### Cationic Resins L and M

As presented in Table 2, cationic resins were prepared in the same manner as cationic resin K, except that the amount of 2,2′-azobis(2-amidinopropane) dihydrochloride added was changed.

### Table 2

TABLE 2
Synthesis conditions and characteristics of cationic resins K to M

| | | | 2,2′-Azobis | | |
|---|---|---|---|---|---|
| | 35% | | (2-amidinopropane) | Total | Molecular |
| Cationic | Hydrochloric acid | Monoallylamine | dihydrochloride | amount | weight at |
| resin | (part) | (part) | (part) | (part) | peak position |
| K | 550 | 286 | 1.00 | 837 | 2000 |
| L | 550 | 286 | 0.01 | 836 | 8500 |
| M | 550 | 286 | 2.00 | 838 | 650 |

### Preparation of Reaction Liquid

Components given in Tables 3 to 5 were mixed and sufficiently stirred. The resulting mixtures were then subjected to pressure filtration through a cellulose acetate filter (manufactured by Advantec Toyo Kaisha, Ltd.) having a pore size of 3.0 μm, thereby preparing reaction liquids.

Viscosities of inks and the reaction liquids were measured with an E-type viscometer (trade name: “RE-85L”, manufactured by Toki Sangyo Co., Ltd.) at 25° C. and 50 rpm.

The dynamic surface tension values were measured at a lifetime of 10 ms with a dynamic surface tensiometer (trade name: “Bubble Pressure Tensiometer BP-2”, manufactured by KRUSS) based on a maximum bubble pressure method. “TSP4446” is the trade name of a silicone oil manufactured by Momentive Performance Materials Japan LLC. “Acetylenol E100” is the trade name of a surfactant manufactured by Kawaken Fine Chemicals Co., Ltd. “Proxel GXL(S)” is the trade name of a preservative manufactured by Lonza.

### Table 3

TABLE 3
(1) Composition and characteristics of reaction liquid

| Reaction liquid No. | | 1 | 2 | 3 | 4 | 5 | 6 | 7 | 8 | 9 | 10 | 11 |
|---|---|---|---|---|---|---|---|---|---|---|---|---|
| Cationic | PAS-H-5L | 0.71 | | | 0.71 | | 0.36 | 3.14 | 0.82 | | | |
| resin | Aqueous solution of | | 1.00 | | | | | | | | | |
| | cationic resin A | | | | | | | | | | | |
| | Aqueous solution of | | | 1.00 | | 1.00 | | | | | | |
| | cationic resin B | | | | | | | | | | | |
| | Aqueous solution of | | | | | | | | | | 1.00 | |
| | cationic resin C | | | | | | | | | | | |
| | Aqueous solution of | | | | | | | | | 1.00 | | |
| | cationic resin D | | | | | | | | | | | |
| | PAS-J-81L | | | | | | | | | | | |
| | Catiomaster PE-30 | | | | | | | | | | | |
| | PAA-HCL-3L | | | | | | | | | | | 0.40 |
| | Aqueous solution of | | | | | | | | | | | |
| | cationic resin K | | | | | | | | | | | |
| | Aqueous solution of | | | | | | | | | | | |
| | cationic resin L | | | | | | | | | | | |
| | Aqueous solution of | | | | 4.00 | | | | | | | |
| | cationic resin E | | | | | | | | | | | |
| | Aqueous solution of | 4.00 | 4.00 | 4.00 | | | 4.95 | 0.55 | 3.90 | 4.00 | 4.00 | |
| | cationic resin F | | | | | | | | | | | |
| | Aqueous solution of | | | | | 4.00 | | | | | | |
| | cationic resin G | | | | | | | | | | | |
| | Aqueous solution of | | | | | | | | | | | |
| | cationic resin H | | | | | | | | | | | |
| | Aqueous solution of | | | | | | | | | | | |
| | cationic resin I | | | | | | | | | | | |
| | PAA-HCL-10L | | | | | | | | | | | 2.00 |
| | EPA-SK01 | | | | | | | | | | | |
| | Aqueous solution of | | | | | | | | | | | |
| | cationic resin M | | | | | | | | | | | |
| | Aqueous solution of | | | | | | | | | | | |
| | cationic resin J | | | | | | | | | | | |
| Polyvalent | Magnesium sulfate | 7.00 | 7.00 | 7.00 | 7.00 | 7.00 | 7.00 | 7.00 | 7.00 | 7.00 | 7.00 | 7.00 |
| metal salt | heptahydrate | | | | | | | | | | | |
| Organic acid | Potassium citrate | | | | | | | | | | | |
| Solvent | 1,2-Butanediol | 3.00 | 3.00 | 3.00 | 3.00 | 3.00 | 3.00 | 3.00 | 3.00 | 3.00 | 3.00 | 3.00 |
| | Thiodiglycol | | | | | | | | | | | |
| | Dimethylethanolamine | | | | | | | | | | | |
| | Diethylene glycol | | | | | | | | | | | |
| | monobutyl ether | | | | | | | | | | | |
| | 1,4-Butanediol | | | | | | | | | | | |
| Surfactant | TSF4446 | | | | | | | | | | | |
| | Acetylenol E100 | 0.50 | 0.50 | 0.50 | 0.50 | 0.50 | 0.50 | 0.50 | 0.50 | 0.50 | 0.50 | 0.50 |
| Preservative | Proxel GXL(S) | 0.20 | 0.20 | 0.20 | 0.20 | 0.20 | 0.20 | 0.20 | 0.20 | 0.20 | 0.20 | 0.20 |

| | | | | | | | | | | | |
|---|---|---|---|---|---|---|---|---|---|---|---|
| Ion-exchanged water | 84.59 | 84.30 | 84.30 | 84.59 | 84.30 | 84.31 | 85.67 | 84.58 | 84.30 | 84.30 | 86.90 |
| Total | 100 | 100 | 100 | 100 | 100 | 100 | 100 | 100 | 100 | 100 | 100 |
| Dynamic surface tension at 10 ms | 33 | 33 | 33 | 33 | 33 | 33 | 33 | 33 | 33 | 33 | 33 |
| (mN/m) | | | | | | | | | | | |
| Viscosity (mPa · s) | 2.0 | 1.7 | 2.2 | 1.9 | 2.5 | 2.2 | 1.8 | 2.0 | 1.9 | 1.9 | 1.9 |

### Table 4

TABLE 4
(2) Composition and characteristics of reaction liquid

| Reaction liquid No. | | 12 | 13 | 14 | 15 | 16 | 17 | 18 | 19 | 20 | 21 | 22 |
|---|---|---|---|---|---|---|---|---|---|---|---|---|
| Cationic | PAS-H-5L | 0.71 | | 0.71 | | | 0.36 | 0.18 | 0.71 | 0.71 | | 0.71 |
| resin | Aqueous solution of | | | | 2.50 | 3.00 | | | | | | |
| | cationic resin A | | | | | | | | | | | |
| | Aqueous solution of | | | | | | | | | | | |
| | cationic resin B | | | | | | | | | | | |
| | Aqueous solution of | | | | | | | | | | | |
| | cationic resin C | | | | | | | | | | | |
| | Aqueous solution of | | | | | | | | | | | |
| | cationic resin D | | | | | | | | | | | |
| | PAS-J-81L | | 0.80 | | | | | | | | | |
| | Catiomaster PE-30 | | | | | | | | | | | |
| | PAA-HCL-3L | | | | | | | | | | | |
| | Aqueous solution of | | | | | | | | | | 1.88 | |
| | cationic resin K | | | | | | | | | | | |
| | Aqueous solution of | | | | | | | | | | 1.88 | |
| | cationic resin L | | | | | | | | | | | |
| | Aqueous solution of | | | | | | | | | | | |
| | cationic resin E | | | | | | | | | | | |
| | Aqueous solution of | | 4.00 | 4.00 | 2.50 | 2.00 | | | 4.00 | 4.00 | 1.25 | 4.00 |
| | cationic resin F | | | | | | | | | | | |
| | Aqueous solution of | | | | | | 4.50 | 4.75 | | | | |
| | cationic resin G | | | | | | | | | | | |
| | Aqueous solution of | | | | | | | | | | | |
| | cationic resin H | | | | | | | | | | | |
| | Aqueous solution of | | | | | | | | | | | |
| | cationic resin I | | | | | | | | | | | |
| | PAA-HCL-10L | | | | | | | | | | | |
| | EPA-SK01 | 6.40 | | | | | | | | | | |
| | Aqueous solution of | | | | | | | | | | | |
| | cationic resin M | | | | | | | | | | | |
| | Aqueous solution of | | | | | | | | | | | |
| | cationic resin J | | | | | | | | | | | |
| Polyvalent | Magnesium sulfate | 7.00 | 7.00 | | 7.00 | 7.00 | 2.00 | 2.00 | 7.00 | 7.00 | | |
| metal salt | heptahydrate | | | | | | | | | | | |
| Organic acid | Potassium citrate | | | | | | | | | | | 7.00 |
| Solvent | 1,2-Butanediol | 3.00 | 3.00 | 3.00 | 3.00 | 3.00 | 3.00 | 3.00 | 3.00 | 3.00 | 3.00 | 3.00 |
| | Thiodiglycol | | | | | | | | | | | |
| | Dimethylethanolamine | | | | | | | | | | | |
| | Diethylene glycol | | | | | | | | | | | |
| | monobutyl ether | | | | | | | | | | | |
| | 1,4-Butanediol | | | | | | | | | | | |
| Surfactant | TSF4446 | | | | | | | | | | | |
| | Acetylenol E100 | 0.50 | 0.50 | 0.50 | 0.50 | 0.50 | 0.50 | 0.50 | 0.22 | 0.18 | 0.18 | 0.50 |
| Preservative | Proxel GXL(S) | 0.20 | 0.20 | 0.20 | 0.20 | 0.20 | 0.20 | 0.20 | 0.20 | 0.20 | 0.20 | 0.20 |

| | | | | | | | | | | | |
|---|---|---|---|---|---|---|---|---|---|---|---|
| Ion-exchanged water | | 84.50 | 91.59 | 84.30 | 84.30 | 71.44 | 71.37 | 84.87 | 84.96 | 91.62 | 84.59 |
| Total | 100 | 100 | 100 | 100 | 100 | 100 | 100 | 100 | 100 | 100 | 100 |
| Dynamic surface tension at 10 ms | 33 | 33 | 33 | 33 | 33 | 33 | 33 | 40 | 41 | 41 | 50 |
| (mN/m) | | | | | | | | | | | |
| Viscosity (mPa · s) | 2.0 | 2.0 | 1.3 | 1.5 | 1.4 | 5.0 | 5.1 | 2.0 | 2.0 | 1.4 | 2.0 |

### Table 5

TABLE 5
(3) Composition and characteristics of reaction liquid

| Reaction liquid No. | | 23 | 24 | 25 | 26 | 27 | 28 | 29 | 30 | 31 | 32 | 33 |
|---|---|---|---|---|---|---|---|---|---|---|---|---|
| Cationic | PAS-H-5L | | 3.57 | | | | 0.71 | 0.71 | 0.29 | 3.21 | | |
| resin | Aqueous solution of | | | | | | | | | | | |
| | cationic resin A | | | | | | | | | | | |
| | Aqueous solution of | | | | | | 4.00 | | | | | |
| | cationic resin B | | | | | | | | | | | |
| | Aqueous solution of | | | | | | | | | | | |
| | cationic resin C | | | | | | | | | | | |
| | Aqueous solution of | | | | | | | | | | | |
| | cationic resin D | | | | | | | | | | | |
| | PAS-J-81L | | | | | | | | | | | |
| | Catiomaster PE-30 | | | | | | | | | | | 1.80 |
| | PAA-HCL-3L | | | | | | | | | | | |
| | Aqueous solution of | | | | | | | | | | | |
| | cationic resin K | | | | | | | | | | | |
| | Aqueous solution of | | | | | | | | | | 7.50 | |
| | cationic resin L | | | | | | | | | | | |
| | Aqueous solution of | | | | | | | | | | | |
| | cationic resin E | | | | | | | | | | | |
| | Aqueous solution of | | | 5.00 | 4.00 | 4.00 | | | 4.95 | 0.50 | | |
| | cationic resin F | | | | | | | | | | | |
| | Aqueous solution of | | | | | | | | | | | |
| | cationic resin G | | | | | | | | | | | |
| | Aqueous solution of | | | | | 1.00 | | | | | | |
| | cationic resin H | | | | | | | | | | | |
| | Aqueous solution of | | | | | | | 4.00 | | | | |
| | cationic resin I | | | | | | | | | | | |
| | PAA-HCL-10L | | | | | | | | | | | |
| | EPA-SK01 | | | | | | | | | | | 0.80 |
| | Aqueous solution of | | | | | | | | | | 12.50 | |
| | cationic resin M | | | | | | | | | | | |
| | Aqueous solution of | | | | 1.00 | | | | | | | |
| | cationic resin J | | | | | | | | | | | |
| Polyvalent | Magnesium sulfate | 7.00 | 7.00 | 7.00 | 7.00 | 7.00 | 7.00 | 7.00 | 7.00 | 7.00 | | |
| metal salt | heptahydrate | | | | | | | | | | | |
| Organic acid | Potassium citrate | | | | | | | | | | | |
| Solvent | 1,2-Butanediol | 3.00 | 3.00 | 3.00 | 3.00 | 3.00 | 3.00 | 3.00 | 3.00 | 3.00 | | |
| | Thiodiglycol | | | | | | | | | | 1.00 | |
| | Dimethylethanolamine | | | | | | | | | | | 1.00 |
| | Diethylene glycol | | | | | | | | | | | 1.00 |
| | monobutyl ether | | | | | | | | | | | |
| | 1,4-Butanediol | | | | | | | | | | | 2.00 |
| Surfactant | TSF4446 | | | | | | | | | | | 0.10 |
| | Acetylenol E100 | 0.50 | 0.50 | 0.50 | 0.50 | 0.50 | 0.50 | 0.50 | 0.50 | 0.50 | | |
| Preservative | Proxel GXL(S) | 0.20 | 0.20 | 0.20 | 0.20 | 0.20 | 0.20 | 0.20 | 0.20 | 0.20 | | |

| | | | | | | | | | | | |
|---|---|---|---|---|---|---|---|---|---|---|---|
| Ion-exchanged water | 89.30 | 85.73 | 84.30 | 84.30 | 84.30 | 84.59 | 84.59 | 84.32 | 85.59 | 7.00 | 66.30 |
| Total | 100 | 100 | 100 | 100 | 100 | 100 | 100 | 100 | 100 | 100 | 100 |
| Dynamic surface tension at 10 ms | 33 | 33 | 33 | 33 | 33 | 33 | 33 | 33 | 33 | 50 | 50 |
| (mN/m) | | | | | | | | | | | |
| Viscosity (mPa · s) | 1.2 | 1.7 | 2.3 | 1.6 | 2.4 | 1.8 | 2.8 | 2.3 | 1.7 | 3.6 | 6.6 |

### Preparation of Pigment Dispersion

### Pigment Dispersion 1

A styrene-ethyl acrylate-acrylic acid copolymer (resin 1) having an acid value of 150 mgKOH/g and a weight-average molecular weight of 8,000 was provided. Then 20.0 parts of resin 1 was neutralized with potassium hydroxide in an amount equimolar to the acid value thereof. An appropriate amount of pure water was added thereto to prepare an aqueous solution of resin 1 having a resin content (solid content) of 20.0%. A mixture was prepared by mixing 10.0 parts of a pigment (C.I. Pigment Blue 15:3), 15.0 parts of the aqueous solution of resin 1 and 75.0 parts of pure water.

The resulting mixture and 200 parts of zirconia beads having a diameter of 0.3 mm were placed into a batch-type vertical sand mill (manufactured by Aimex Co., Ltd.) and dispersed for 5 hours while the sand mill was cooled with water. After removing a coarse particle by centrifugation, pressure filtration was performed with a cellulose acetate filter (manufactured by Advantec Toyo Kaisha, Ltd.) having a pore size of 3.0 μm to prepare pigment dispersion 1 having a pigment content of 10.0% and a resin dispersant (resin 1) content of 3.0%.

### Pigment Dispersion 2

Pigment dispersion 2 having a pigment content of 10.0% and a resin dispersant (resin 1) content of 3.0% was prepared by the same procedure as that for pigment dispersion 1, except that the pigment was changed to C.I. Pigment Red 122.

### Pigment Dispersion 3

Pigment dispersion 3 having a pigment content of 10.0% and a resin dispersant (resin 1) content of 3.0% was prepared by the same procedure as that for pigment dispersion 1, except that the pigment was changed to C.I. Pigment Yellow 74.

### Pigment Dispersion 4

A pigment dispersion liquid 4 having a pigment content of 10.0% and a resin dispersant (resin 1) content of 3.0% was prepared by the same procedure as that for pigment dispersion 1, except that the pigment was changed to carbon black.

### Pigment Dispersion 5

First, 1.6 g of 4-amino-1,2-benzenedicarboxylic acid was added to a solution of 5 g of concentrated hydrochloric acid in 5.5 g of water while the solution was being cooled to 5° C. A container containing this solution was placed in an ice bath to maintain the solution at 10° C. or lower at all times. A solution of 0.9 g of sodium nitrite in 9.0 g of water at 5° C. was added thereto. The resulting solution was stirred for 15 minutes, and then 6 g of C.I. Pigment Blue 15:3 was added thereto under stirring. The mixture was then stirred for another 15 minutes. The resulting slurry was filtered through filter paper (trade name: Standard Filter Paper No. 2, manufactured by Advantec Toyo Kaisha, Ltd.). Then the particle was sufficiently washed with water. The particle was dried in an oven at 110° C. to prepare a self-dispersible pigment. Water was added to the resulting self-dispersible pigment in such a manner that the pigment content was 10.0%, thereby preparing a dispersion. By the above method, a pigment dispersion was prepared in which a self-dispersible pigment having a —C₆H₃—(COONa)₂ group introduced to a pigment particle surface was dispersed in water. Thereafter, a sodium ion in the pigment dispersion was replaced with a potassium ion by an ion exchange method, thereby preparing pigment dispersion 5 having a pigment content of 10.0% by mass and containing a self-dispersible pigment dispersed therein, the pigment having a benzenedicarboxylic acid group, whose counter ion was a potassium ion, bonded to the surface of the pigment.

### Production of Resin Particle

### Resin Particle 1

In a four-necked flask equipped with a stirrer, a reflux condenser and a nitrogen gas inlet, 0.2 parts of potassium persulfate and 74.0 parts of ion-exchanged water were mixed, thereby preparing a solution. Then 24.0 parts of ethyl methacrylate, 1.5 parts of methacrylic acid and 0.3 parts of a reactive surfactant (trade name: Aqualon KH-05, manufactured by DKS Co., Ltd.) were mixed to prepare an emulsion. The emulsion was added dropwise to the solution over one hour under a nitrogen atmosphere, and polymerization was performed under stirring at 80° C., followed by stirring for another two hours. After the mixture was cooled to room temperature (25° C.), ion-exchanged water and an aqueous solution of potassium hydroxide were added to give an aqueous dispersion of resin particle 1 having a resin particle content of 25.0%.

### Preparation of Ink

Components (unit: %) given in Table 6 were mixed. The resulting mixtures were sufficiently stirred and subjected to pressure filtration through cellulose acetate filters (manufactured by Advantec Toyo Kaisha, Ltd.) having a pore size of 3.0 μm to prepare respective inks. “Acetylenol E100” is the trade name of a surfactant manufactured by Kawaken Fine Chemicals Co., Ltd.

### Table 6

TABLE 6
Composition of ink

| Ink No. | 1 | 2 | 3 | 4 | 5 |
|---|---|---|---|---|---|
| Pigment dispersion 1 | 40.00 | | | | |
| Pigment dispersion 2 | | 40.00 | | | |
| Pigment dispersion 3 | | | 40.00 | | |
| Pigment dispersion 4 | | | | 40.00 | |
| Pigment dispersion 5 | | | | | 40.00 |
| 1,2-Butanediol | 15.00 | 15.00 | 15.00 | 15.00 | 15.00 |
| Aqueous dispersion of | 20.00 | 20.00 | 20.00 | 20.00 | 20.00 |
| resin particle 1 | | | | | |
| Acetylenol E100 | 1.00 | 1.00 | 1.00 | 1.00 | 1.00 |
| Proxel GXL(S) | 0.20 | 0.20 | 0.20 | 0.20 | 0.20 |
| Ion-exchanged water | 23.80 | 23.80 | 23.80 | 23.80 | 23.80 |
| Total | 100 | 100 | 100 | 100 | 100 |

### Evaluation

Image unevenness and image unevenness at the recording start portion after a discharge stop were evaluated using the ink jet recording apparatus 100 having the configuration illustrated in FIG. 1. The reaction liquid applying device 1201 and the ink applying device 1202 in the recording portion 1000 were filled with the reaction liquid and the ink, respectively, and the evaluation was performed. In the ink jet recording apparatus 100, an image recorded under the condition in which one ink droplet having a weight of 4.0 ng is applied to a unit region of 1/1,200 inches× 1/1,200 inches is defined as a recording duty of 100%.

Image fading due to sticking matter at the ink head discharge port was evaluated using a PIXUS Pro10S printer as described below.

In the examples of the present invention, “AAA”, “AA”, “A” and “B” were regarded as acceptable levels, and “C” was regarded as an unacceptable level in the evaluation criteria of the following items. The evaluation results are presented on the right side of Table 7.

### Image Unevenness of Solid Image

A 15 cm×15 cm solid image having a recording duty of the reaction liquid of 30% and a recording duty of the ink of 100% was recorded using a combination of a reaction liquid and an ink given in Table 7. The resulting image was allowed to stand for 24 hours under conditions of a temperature of 23° C. and a humidity of 50%, and then scanned using a scanner (manufactured by Seiko Epson Corporation, trade name: OFFIRIOES-10000G) under the following conditions: mode: professional, resolution: 300 dpi and color: 24 bit. Art paper (manufactured by Lintec Corporation, trade name: Art PW8k, amount of water absorbed from the start of contact to 30 msec^{1/2} in the Bristow method: 9.5 mL/m²) was used as a recording medium.

Photoshop was used. A reference image sample (recorded material with no unevenness in the image) was prepared, cut into a size of 50 pixels×100 pixels, converted to grayscale and pasted onto a new clipboard.

In the binarization of color tone correction, the threshold value (T) of the binarization boundary was lowered one by one, and the point being in contact with the bottom of the peak was set as the threshold value.

The evaluation image sample was cut into a size of 50 pixels×100 pixels, converted to grayscale and pasted onto a new clipboard. The binarization of color tone correction was performed.

The threshold value (T) determined above was used as the threshold value of the binarization boundary, and the ratio, which was the ratio of the number of pixels (i.e. the number of pixels where the coloring material was present) greater than or equal to the threshold value (T) out of 50 pixels×100 pixels, was determined from the histogram.
AAA: The histogram ratio was 99.6 or more
AA: The histogram ratio was 99.5 or more to less than 99.6.
A: The histogram ratio was 99.4 or more to less than 99.5.
B: The histogram ratio was 99.3 or more to less than 99.4.
C: The histogram ratio was less than 99.3.
   Image Unevenness at Recording Start Portion after Discharge Stop

Images were recorded with a reaction liquid recording duty of 30% and an ink recording duty of 100% using the combinations of the reaction liquid and the ink given in Table 7. At this time, in an environment of a temperature of 15° C. and a relative humidity of 10%, 10,000 droplets of the ink were discharged from all the discharge ports of the recording head at a drive frequency of 5 kHz to record the image. After a blank space of 0.5 inches was provided, the ink and the reaction liquid were discharged to record a solid image of 15 cm×15 cm on the recording medium under the same condition. Subsequently, the discharge of the ink was not stopped, but the discharge of only the reaction liquid was stopped for a certain period of time (3 to 6 seconds). The reaction liquid was then discharged from the same discharge port as above to record a solid image of 15 cm×15 cm again.

In this manner, the states of the two solid images recorded before and after the discharge of the reaction liquid was stopped for a certain period of time were visually checked, and the intermittent discharge stability was evaluated according to the following evaluation criteria. Art paper (Art PW8k, manufactured by Lintec Corporation) was used as the recording medium.
AA: The evenness of the solid image after the discharge of the reaction liquid was stopped for 6 seconds was equivalent to that before the discharge was stopped.
A: The evenness of the solid image after the discharge of the reaction liquid was stopped for 5 seconds was equivalent to that before the discharge was stopped.
B: The evenness of the solid image after the discharge of the reaction liquid was stopped for 4 seconds was equivalent to that before the discharge was stopped.
C: For the solid image after the discharge of the reaction liquid was stopped for 3 seconds, unevenness was observed in the starting portion of the discharge of the reaction liquid as compared with that before the discharge was stopped.

### Image Fading Due to Sticking Matter at Head Discharge Port

The combination of the reaction liquid and the ink given in Table 7 was used. A tank filled with the reaction liquid was mounted at the PC tank mounting position of the PIXUS Pro10S printer. Tanks filled with the same ink were mounted at the GY tank and PBK tank mounting positions, and printing was performed using the recording heads for two colors.

Printing was performed as follows: Regarding the scanning direction of the recording head, the movement from a cap mounting position (home position) to a tank replacement position was defined as a forward direction. An image was formed in a single scanning movement in the forward direction. No printing was performed in a backward direction. In other words, recording was performed with one pass printing in the forward direction. Printing was always performed by a printing method in which ink was applied after the reaction liquid was applied.

In the ink jet recording apparatus 100, an image recorded under the condition in which one ink droplet is applied to a unit region of 1/1,200 inches× 1/1,200 inches is defined as a recording duty of 100%.

A pattern for forming a solid image on the entire surface of an A4 sheet was continuously recorded on a predetermined number of sheets at a recording duty of the reaction liquid of 30% and a recording duty of the ink of 100%. Thereafter, 6-point Gothic characters were printed with the above-described amounts of the ink and the reaction liquid applied. The sticking resistance was evaluated by checking whether the discharge failure was caused by sticking matter formed on the discharge port surfaces of the heads. Recording was performed on a recording medium (plain paper, trade name “CS-064F”, manufactured by CANON KABUSHIKI KAISHA). The evaluation criteria for sticking resistance are described below.
AAA: After recording on 200 sheets, no defects were observed in the characters, and the result was good.
AA: After recording on 150 sheets, no defects were observed in the characters, and the result was good.
A: After recording on 100 sheets, no defects were observed in the characters, and the result was good.
B: After recording on 50 sheets, no defects were observed in the characters, and the result was good.
C: After recording on 50 sheets, many defects were observed in the characters.

### Table 7

TABLE 7
Evaluation conditions and evaluation results

| | | | | Image | Image unevenness at | |
|---|---|---|---|---|---|---|
| | | Reaction | | unevenness of | recording start portion | Sticking |
| | No. | liquid | Ink | solid image | after discharge stop | resistance |
| Example | 1 | 1 | 1 | AAA | AA | AAA |
| | 2 | 1 | 2 | AAA | AA | AAA |
| | 3 | 1 | 3 | AAA | AA | AAA |
| | 4 | 1 | 4 | AAA | AA | AAA |
| | 5 | 1 | 5 | AAA | AA | AAA |
| | 6 | 2 | 5 | AAA | AA | AA |
| | 7 | 3 | 5 | AAA | AA | AAA |
| | 8 | 4 | 5 | AAA | AA | AAA |
| | 9 | 5 | 5 | AAA | AA | AAA |
| | 10 | 6 | 5 | AAA | AA | AAA |
| | 11 | 7 | 5 | AAA | AA | AA |
| | 12 | 8 | 5 | AAA | AA | AAA |
| | 13 | 9 | 5 | AAA | AA | AAA |
| | 14 | 10 | 5 | AAA | AA | AA |
| | 15 | 11 | 5 | AAA | AA | AA |
| | 16 | 12 | 5 | AAA | AA | AA |
| | 17 | 13 | 5 | AAA | AA | A |
| | 18 | 14 | 5 | AAA | AA | AA |
| | 19 | 15 | 5 | AAA | AA | AAA |
| | 20 | 16 | 5 | AAA | AA | AA |
| | 21 | 17 | 5 | AAA | AA | AAA |
| | 22 | 18 | 5 | AAA | A | AAA |
| | 23 | 19 | 5 | AAA | AA | AAA |
| | 24 | 20 | 5 | AA | AA | AAA |
| | 25 | 21 | 5 | A | AA | B |
| | 26 | 22 | 5 | AAA | AA | AAA |
| Comparative | 1 | 23 | 5 | C | AA | C |
| Example | 2 | 24 | 5 | AA | AA | C |
| | 3 | 25 | 5 | AA | C | AAA |
| | 4 | 26 | 5 | AAA | AA | C |
| | 5 | 27 | 5 | AAA | C | AAA |
| | 6 | 28 | 5 | AAA | AA | C |
| | 7 | 29 | 5 | AAA | C | AAA |
| | 8 | 30 | 5 | AAA | C | AAA |
| | 9 | 31 | 5 | AAA | AA | C |
| | 10 | 32 | 5 | B | AA | C |
| | 11 | 33 | 5 | B | AA | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139405 filed Aug. 30, 2023 and No. 2024-131739 filed Aug. 8, 2024, which are hereby incorporated by reference herein in their entirety.

What is claimed is:

1. An ink jet recording method for recording an image on a recording medium using an aqueous ink and an aqueous reaction liquid containing a reactant that reacts with the aqueous ink, the method comprising:
a reaction liquid applying step of applying the aqueous reaction liquid to the recording medium by discharging the aqueous reaction liquid from an ink jet recording head; and
an ink applying step of applying the aqueous ink to the recording medium by discharging the aqueous ink from an ink jet recording head in such a manner as to overlap at least a portion of a region of the recording medium to which the aqueous reaction liquid is applied,
wherein the reactant comprises a cationic resin,
the cationic resin comprises, in a molecular weight distribution measured by gel permeation chromatography:
a first cationic resin having a peak in a molecular weight range of 100,000 or more to 500,000 or less, and
a second cationic resin having a peak in a molecular weight range of 2,000 or more to less than 100,000, and
wherein a mass ratio of an amount (% by mass) of the second cationic resin contained to an amount (% by mass) of the first cationic resin contained is 0.01 times or more to 8.0 times or less.

2. The ink jet recording method according to claim 1, wherein the mass ratio of the amount (% by mass) of the second cationic resin contained to the amount (% by mass) of the first cationic resin contained is 0.01 times or more to 0.30 times or less.

3. The ink jet recording method according to claim 1, wherein, in a molecular weight distribution of the reaction liquid measured by gel permeation chromatography, the second cationic resin has a peak in a molecular weight range of 10,000 or more to less than 100,000.

4. The ink jet recording method according to claim 1, wherein each of the first cationic resin and the second cationic resin has a quaternary ammonium salt structure.

5. The ink jet recording method according to claim 1, wherein the first cationic resin and the second cationic resin have an identical repeating structural unit.

6. The ink jet recording method according to claim 1, wherein each of the first cationic resin and the second cationic resin is a polymer having a repeating structural unit represented by the following general formula (1): 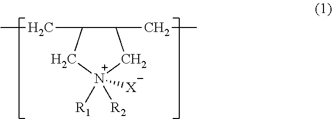
where R₁ and R₂ are each independently an alkyl group, and X⁻ is a counter anion of a quaternary ammonium cation.

7. The ink jet recording method according to claim 1, wherein the reactant comprises a polyvalent metal salt.

8. The ink jet recording method according to claim 1, wherein the reaction liquid has a dynamic surface tension of 40 mN/m or less at a lifetime of 10 ms.

9. The ink jet recording method according to claim 1, wherein the reaction liquid has a viscosity of 1.5 mPa·s or more to 5.0 mPa·s.

10. The ink jet recording method according to claim 1, wherein an amount of water absorbed by the recording medium from a start of contact to 30 msec^{1/2} in a Bristow method is 10 mL/m² or less.

11. An ink jet recording apparatus for use in an ink jet recording method for recording an image on a recording medium using an aqueous ink and an aqueous reaction liquid containing a reactant that reacts with the aqueous ink, the apparatus comprising:
an ink jet-type reaction liquid applying unit configured to apply the aqueous reaction liquid to a recording medium by discharging the aqueous reaction liquid; and
an ink jet-type ink applying unit configured to apply the aqueous ink to the recording medium by discharging the aqueous ink in such a manner as to overlap at least a portion of a region of the recording medium to which the aqueous reaction liquid is applied,
wherein the reactant comprises a cationic resin,
the cationic resin comprises, in a molecular weight distribution measured by gel permeation chromatography:
a first cationic resin having a peak in a molecular weight range of 100,000 or more to 500,000 or less, and
a second cationic resin having a peak in a molecular weight range of 2,000 or more to less than 100,000, and
wherein a mass ratio of an amount (% by mass) of the second cationic resin contained to an amount (% by mass) of the first cationic resin contained is 0.01 times or more to 8.0 times or less.

12. A set of an aqueous ink and an aqueous reaction liquid, the set being used for an ink jet recording method for recording an image on a recording medium using the aqueous ink and the aqueous reaction liquid containing a reactant that reacts with the aqueous ink, wherein the method includes:
a reaction liquid applying step of discharging the aqueous reaction liquid from an ink jet recording head to apply the aqueous reaction liquid to the recording medium; and
an ink applying step of applying the aqueous ink to the recording medium by discharging the aqueous ink from an ink jet recording head in such a manner as to overlap at least a portion of a region of the recording medium to which the aqueous reaction liquid is applied,
wherein the reactant comprises a cationic resin,
the cationic resin comprises, in a molecular weight distribution measured by gel permeation chromatography:
a first cationic resin having a peak in a molecular weight range of 100,000 or more to 500,000 or less, and
a second cationic resin having a peak in a molecular weight range of 2,000 or more to less than 100,000, and
wherein a mass ratio of an amount (% by mass) of the second cationic resin contained to an amount (% by mass) of the first cationic resin contained is 0.01 times or more to 8.0 times or less.
